(19) United States
(12) Patent Application Publication
(10) Pub. No.: US 2023/0344921 A1
(43) Pub. Date: Oct. 26, 2023

(54) SYSTEMS AND METHODS FOR UDP NETWORK TRAFFIC ROUTING TO DISTRIBUTED DATA CENTERS VIA CLOUD VPN

(71) Applicant: Citrix Systems, Inc., Fort Lauderdale, FL (US)

(72) Inventors: Pary Duraisamy, Bangalore (IN); Pradeep Gaikwad, Bangalore (IN); Kirankumar Alluvada, Bangalore (IN); Jong Kann, Santa Clara, CA (US); Kenneth Bell, Oswestry (GB)

(21) Appl. No.: 17/723,784

(22) Filed: Apr. 19, 2022

(51) Int. Cl. H04L 12/46; H04L 45/74; H04L 9/40; H04L 69/16

(52) U.S. Cl. CPC H04L 69/161; H04L 12/4641; H04L 45/74; H04L 63/0272; H04L 63/166; H04L 2212/00

(57) ABSTRACT

The present solution provides systems and methods for supporting network communication, including UDP network communication, between clients and servers at data centers, over a cloud VPN. An agent can receive a user datagram protocol (UDP) packet. The agent can generate a header for the UDP packet identifying a destination server at a data center of a plurality of data centers. The agent can establish a channel to a virtual private network (VPN) server of a cloud-based VPN as a service. The agent can encapsulate the UDP packet using the header and transmit, via the channel, the encapsulated UDP packet to the VPN server, the encapsulated UDP packet configured to identify the data center according to a table of the VPN server and content of the header.

### FIELD OF THE DISCLOSURE

The present application generally relates to computing systems and environments, including but not limited to systems and methods for managing network traffic.

### BACKGROUND

Network communication is increasingly utilizing cloud technologies. As users access online resources that can be provided by various remote servers and network devices, the network traffic of the users can increasingly be associated with various cloud based products or services. Sometimes client interaction with particular services or resources on the network may involve relying on the cloud products and services to handle various aspects of network traffic delivery.

### SUMMARY

This summary is provided to introduce a selection of concepts in a simplified form that are further described below in the Detailed Description. This Summary is not intended to identify key features or essential features, nor is it intended to limit the scope of the claims included herewith.

The present solution can relate to a method, such as a method for managing UDP network traffic over a cloud virtual private network. The method can include receiving, by an agent of a client device, a user datagram protocol (UDP) packet. The method can include generating, by the agent, a header for the UDP packet identifying a destination server at a data center of a plurality of data centers. The method can include establishing, by the agent, a channel to a virtual private network (VPN) server of a cloud-based VPN as a service. The method can include encapsulating, by the agent, the UDP packet using the header. The method can include transmitting, by the agent via the channel, the encapsulated UDP packet to the VPN server. The encapsulated UDP packet can be configured to identify the data center according to a table of the VPN server and content of the header.

The method can include forming or configuring the encapsulated UDP packet to identify, based on (or according to) the table of the VPN server, a connector of the data center to which to forward the encapsulated UDP data packet. The method can include receiving, by the agent, the UDP packet from an application of the client device. The method can include establishing, by the agent, the channel to the VPN server, using one of a datagram transport layer security (DTLS) or a transport layer security (TLS).

The method can include generating, by the agent, the content of the header identifying the client device, the destination server, a length of the encapsulated UDP packet and an identification of the user session corresponding to the UDP packet. The method can include receiving, by an agent of a client device, a second UDP packet. The method can include generating, by the agent, a second header for the second UDP packet identifying a second destination server at a second data center of a plurality of data centers. The method can include encapsulating, by the agent, the second UDP packet using the header. The method can include transmitting, by the agent via the channel, the encapsulated second UDP packet to the VPN server, the encapsulated second UDP packet configured to identify the second data center according to the table of the VPN server and content of the second header.

The method can include the agent receiving a UDP domain name system (DNS) query from an application of the client device, transmitting, to the application, a UDP DNS response using a first internet protocol (IP) address, and receiving the UDP packet via a transmission control protocol (TCP) connection established between the application and the agent using the first IP address.

The present solution can relate to a method for a VPN server on a cloud VPN to handle or control UDP traffic between clients and data centers. The method can include receiving, by a virtual private network (VPN) server of a cloud-based VPN as a service, an encapsulated user datagram protocol (UDP) packet comprising a header identifying a destination server. The method can include identifying, by the VPN server from a plurality of data centers, according to a table of the VPN server matching a portion of the header of the encapsulated UDP packet, a data center having the destination server. The method can include selecting, by the VPN server responsive to identifying the data center, a channel between the VPN server and a connector of the data center. The method can include transmitting, by the VPN server via the channel to the connector of the data center, the encapsulated UDP packet for the connector to identify the destination server from a plurality of destination servers of the data center.

The method can include establishing, by one of the connector or the VPN server, the channel to the connector using one of a datagram transport layer security (DTLS) or a transport layer security (TLS). The method can include identifying, by the VPN server, the data center according to an entry in the table of the server matching one of an IP address or a domain name of the header.

The present solution can relate to a system for handling network traffic. The system can be a system for handling UDP network traffic between clients and remote data centers, via cloud VPN. The system can include an agent executing on a processor of a client device coupled to memory. The agent can receive a user datagram protocol (UDP) packet. The agent can generate a header for the UDP packet identifying a destination server at a data center of a plurality of data centers. The agent can establish a channel to a virtual private network (VPN) server of a cloud-based VPN as a service. The agent can encapsulate the UDP packet using the header. The agent can transmit, via the channel, the encapsulated UDP packet to the VPN server. The encapsulated UDP packet can be configured to identify the data center according to a table of the VPN server and content of the header.

The encapsulated UDP packet can be configured to identify, based on the table of the VPN server, a connector of the data center to which to forward the encapsulated data packet. The system can include the agent receive the UDP packet from an application of the client device. The system can include the agent establishing the channel to the VPN server using one of a datagram transport layer security (DTLS) or a transport layer security (TLS). The agent can generate the content of the header identifying the client device, the destination server, a length of the encapsulated UDP packet and an identification of the user session corresponding to the UDP packet.

The system can include the agent receiving a second UDP packet and generating a second header for the second UDP packet identifying a second destination server at a second data center of the plurality of data centers. The agent can encapsulate the second UDP packet using the second header and transmits, via the channel, the second encapsulated UDP packet to the VPN server. The second encapsulated UDP packet can be configured to identify the second data center according to the table of the VPN server and content of the second header.

The system can include the agent receiving a UDP domain name system (DNS) query from an application of the client device. The agent can transmit, to the application, a UDP DNS response using a first internet protocol (IP) address. The agent can receive the UDP packet via a TCP connection established between the application and agent using the first IP address. The system can include the encapsulated UDP packet further configured for a connector of the data center to identify the destination server of a plurality of destination servers of the data center.

The system can include the agent receiving, from the VPN server via the channel, a second encapsulated UDP packet comprising a second UDP packet sent from the destination server to an application of the client device. The agent can decapsulate (e.g., un-encapsulate or remove/undo/reverse the encapsulation) the second encapsulated UDP packet to extract the second UDP packet. The agent can transmit the second UDP packet to the application. The system can include the agent identifying the application according to a second header of the second encapsulated UDP packet.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of an appliance for processing communications between a client and a server, in accordance with an illustrative embodiment;

FIG. 3 includes a block diagram of an example system of a computing environment in which clients can exchange UDP network traffic with servers at a remote data center, via one or more multiplex (MUX) communication channels, in accordance with an illustrative embodiment;

FIG. 4 includes a block diagram of an example system in which UDP network traffic can be communicated between clients and data centers, via client-side and back-end MUX channels interacting with one or more servers of a cloud VPN, in accordance with an illustrative embodiment;

FIG. 5 includes a block diagram of an example system in which multiple data centers can exchange UDP network traffic over multiple back-end MUX channels with a single client device, in accordance with an illustrative embodiment;

FIG. 6 includes a block diagram of an example system in which multiple client devices can utilize multiple client-side MUX channels to access a single data center via a single back-end MUX channel, in accordance with an illustrative embodiment;

FIG. 7 includes a block diagram of an example system in which multiple client devices can exchange UDP network traffic with remote data centers via client side channels between clients and VPN servers and back-end channels between VPN servers and data centers, in accordance with an illustrative embodiment;

FIG. 8 includes a block diagram of an example system in which a VPN server of a cloud VPN includes a routing table for routing the UDP traffic between the one or more clients and one or more data centers, in accordance with an illustrative embodiment;

FIG. 9 is a diagram of a process for implementation of UDP DNS in which a spoofing IP address for DNS resolution can be used, such as for example for Type A or AAAA records, in accordance with an illustrative embodiment;

FIG. 10 is a diagram of a process for implementation of a UDP DNS resolution by remote data centers, in accordance with an illustrative embodiment;

FIG. 11 is a diagram of a process for resolving TCP DNS queries in which a cloud VPN can intercept and filter TCP DNS queries over one or more MUX channels, in accordance with an illustrative embodiment;

FIG. 12 is a diagram of a process for a TCP DNS resolution in which a client can support split DNS remote implementation for TCP based DNS query, in accordance with an illustrative embodiment;

FIG. 13 is a diagram of a process for a TCP DNS resolution providing for a client to support split DNS local implementation for TCP based DNS query, in accordance with an illustrative embodiment;

FIG. 14 is a diagram of a process for a TCP DNS solution providing for a client to spoof IP for TCP based DNS query for records type “A” and/or “AAAA”, in accordance with an illustrative embodiment; and

FIG. 15 is a flow diagram of an example method for supporting UDP communication over MUX channels and via a cloud VPN, in accordance with an illustrative embodiment.

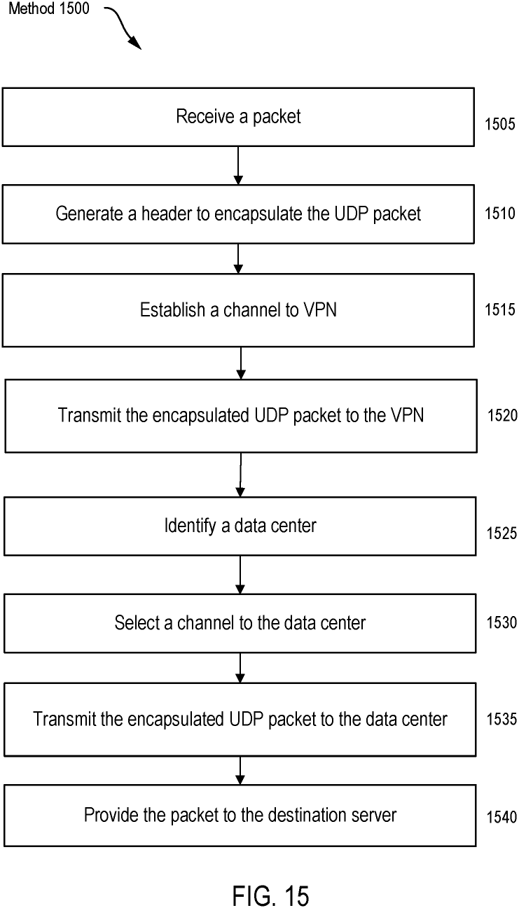

### DETAILED DESCRIPTION

Network traffic can be communicated through on-premises virtual private network (VPN). The on-premises VPN can be implemented in a subnetwork of an exposed, outward-facing services of an organization, which can sometimes be referred as a demilitarized zone (DMZ). A DMZ can, for example include its own private network 104, with own servers 106 or 195 providing services for clients. Port forwarding, or tunneling of user datagram protocol (UDP) network traffic through the interior of a DMZ can be implemented such that UDP packets from various clients can arrive to an on-premises VPN in a DMZ and be delivered to the right UDP server destination within the Local Area Network (LAN).

However, in the instances in which a customer, such as an enterprise, conducts business across several regions and includes distributed data centers via cloud VPN services, tunneling UDP network communication across different data centers can be challenging. When clients of a customer enterprise exchange UDP network traffic across distributed data centers via a Cloud VPN (e.g., a cloud-based service/system that securely connects a peer network to a virtual private cloud network, through a VPN connection), delivering UDP packets to correct data centers and correct destination servers in such data centers can be difficult. For example, a client can be connected to one region’s Cloud VPN whereas a data center can be registered and connected to another region’s Cloud VPN. Linking the UDP traffic across such distributed multi region Cloud VPNs can result in UDP packets from a sender in one VPN region to not arrive to the intended destinations in another region. Challenges can arise, for example, from the UDP infrastructure not being capable of knowing IP and other network identifiers of resources in different regions. This can occur, for example, when multiple clients send UDP traffic to a single UDP server in one of the data centers, or when a single client sends UDP traffic to multiple UDP servers distributed across multiple data centers. Maintaining one to one mapping connection for each client to a UDP server in the intended data center can consume a lot of resources of Cloud VPN in the event that there are many simultaneous clients. Yet should a Cloud VPN go down in one region, a client may prefer to continue communicating and have the system find a different route with different region Cloud VPN to reach the intended backend data center.

To resolve these issues, the present solution provides for systems and methods utilizing headers for encapsulating UDP network traffic so as to enable a reliable delivery of the UDP packets across multiple regions of Cloud VPN. The present technical solution enables clients/users in all of these scenarios to have reliable network communication regardless of theirs and their destination server’s location or region.

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for traffic tunneling or routing to distributed customer data centers using cloud VPN

### A. Network and Computing Environment

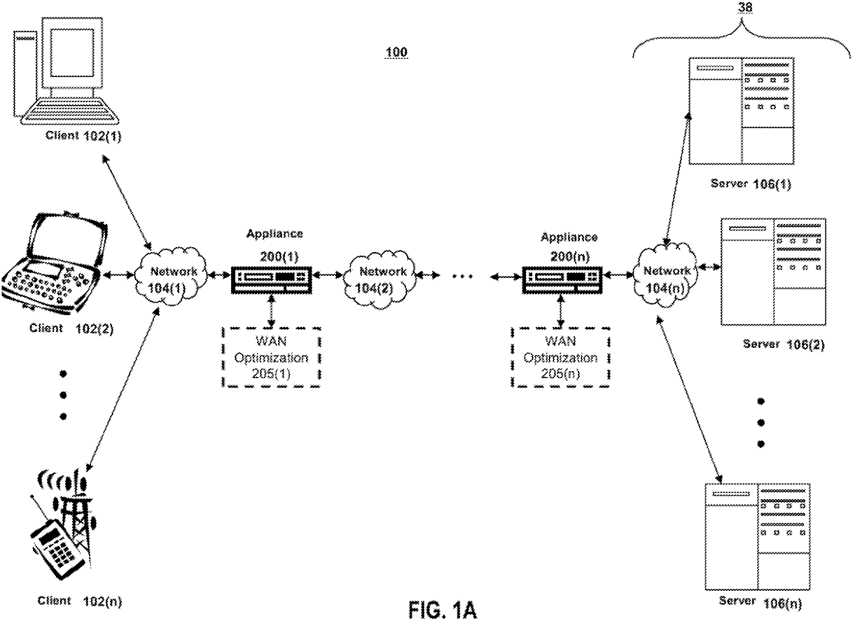

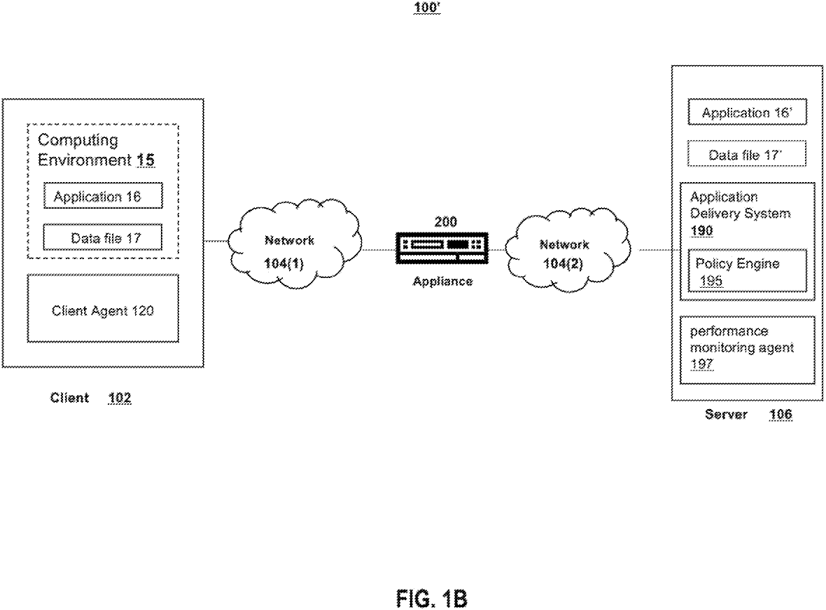

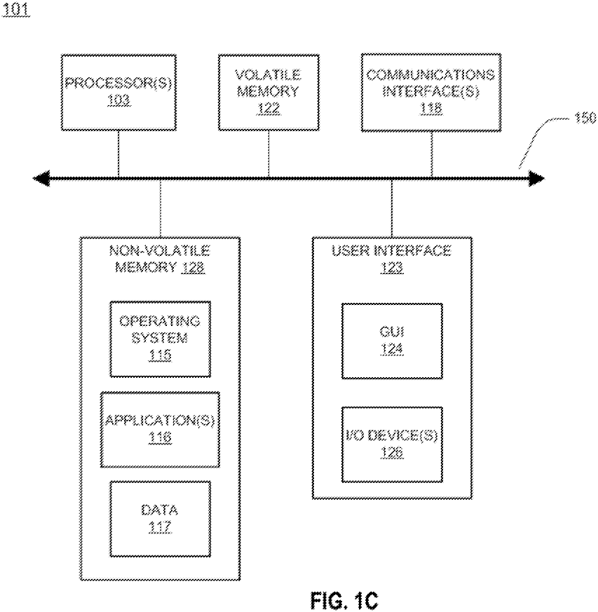

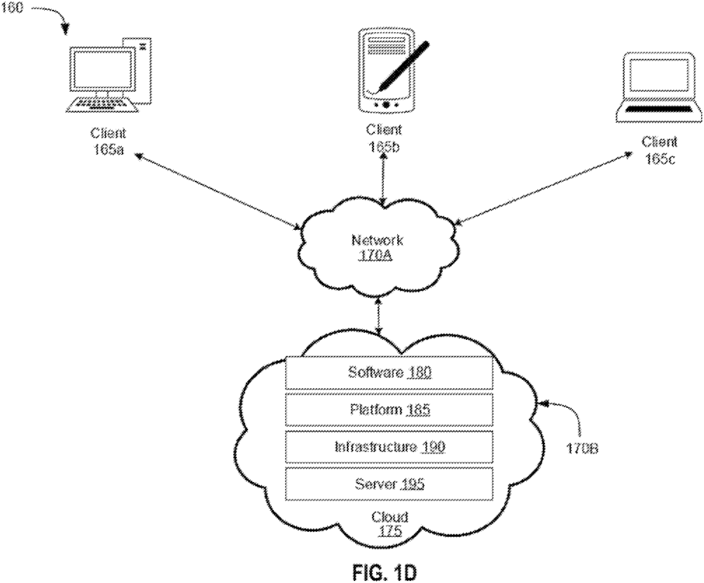

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, FL, the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 can include any functionality or features of clients 102 and vice versa. Clients 165 may include, e.g., thick clients, thin clients, and zero clients. The cloud 175 may include back end platforms, e.g., servers 195, storage, and server farms or data centers. Clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

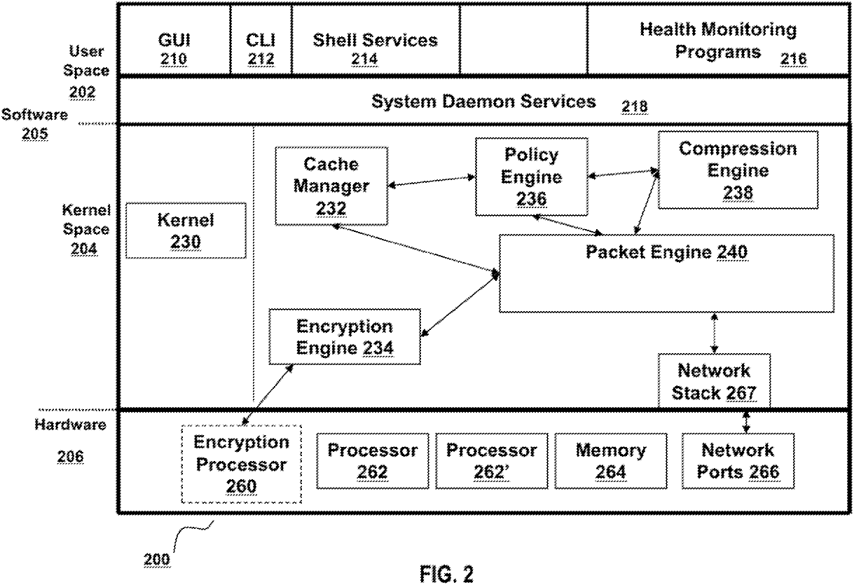

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client’s connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, FL, the teachings of which are hereby incorporated herein by reference.

### C. Systems and Methods for UDP Traffic Routing Over Cloud to Distributed Data Centers

Systems and methods provided herein provide solutions to challenges involving UDP network traffic communication over cloud VPN to distributed data centers. The present solution enables routing of UDP packets, across cloud VPN, to intended remote UDP server destinations in various regions or private VPNs using dedicated multiplex communication channels, also referred to as MUX channels. As on-premises VPNs can correspond to one or more customer DMZs and can include a direct LAN access to the targeted destination UDP servers, the VPN devices or services can deliver each received UDP packet to the intended specific destination UDP server within a LAN. The present solution can therefore provide a seamless UDP network traffic delivery from the client, across the cloud VPN to the intended UDP servers in remote customer data centers. The UDP traffic can be tunneled securely to the UDP server in a specific data center through multiple secure multiplex channels, which can also be referred to as MUX channels.

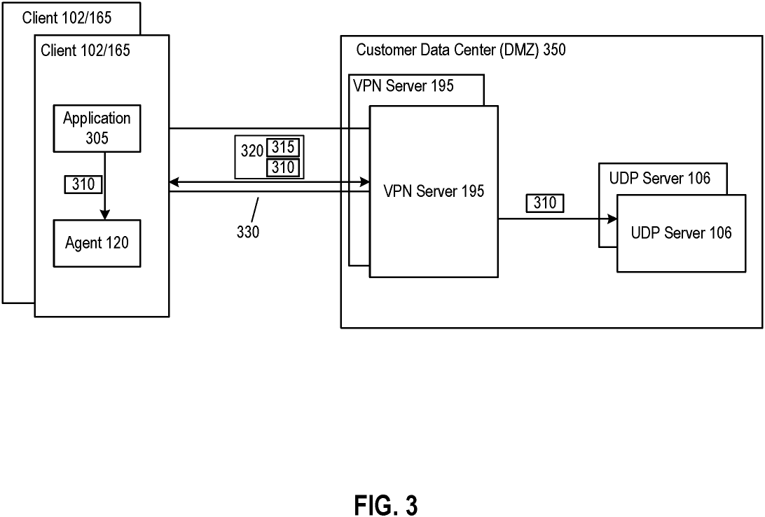

Referring now to FIG. 3, at a high level, FIG. 3 depicts an embodiment of a computing environment 160 in which one or more clients 102 or 165 exchange UDP network traffic across one or more MUX channels 330 with one or more servers 195 at a remote data center 350. Clients 102/165 can generate or receive UDP packets 310 from any number of applications 305 that can be locally executing on the client 102/165 or can be remote from the client. Agents 120 executing on the client 102/106 can receive the UDP packets 310 and can encapsulate them with headers 315 to create encapsulated UDP packets 320. Agents 120 can then transmit encapsulated packets 320, over a MUX channel 330, to a VPN server 195 at a remote data center (e.g., a DMZ) 350. VPN servers 195 can receive encapsulated UDP packets 320, can decapsulate the received UDP packets 320, and based on the content of their headers 315, can identify the intended destination UDP servers 106 to which to forward the decapsulated UDP packets 310.

An application 305 on a client 102/106 generating UDP packets 310 can include any application that can generate UDP network data, including UDP data packets 310. Application 305 can include, for example, an application 16 or any application discussed herein. Application 305 can include, for example, a streaming audio or video application, a secure shell application, a remote desktop application, an email application or any other application that can utilize or generate UDP network traffic. Client 102/165 can run any number of applications 305, or can receive network data, such as UDP packets 310, from any number of applications 305 on a network, such as a network 104.

UDP packet 310 can include any user datagram protocol data packet. UDP packet 310 can include a datagram. UDP packet 310 can include a datagram header and a data section. Datagram header can include any number of fields, such as four fields, for example. UDP packet 310 can include a data section that can include the payload data of an application, such as application 305.

In addition to the aforementioned features, agent 120 can include any features for processing UDP network traffic. Agent 120 can include programming code, functions and scripts for processing UDP data packets 310, generating or creating headers 315 for UPD data packets 310 and/or creating encapsulated UDP packets 320 using headers 315. Encapsulated UDP packets 320 can also be referred to as MUX header 315 packets. Conversely, agent 120 can include the functionality to decapsulate encapsulated UDP packets 320, read headers 315 and/or deliver data packets 310 to their corresponding application(s) 305.

Agent 120 can include or work together with a plugin for monitoring and processing UDP network traffic. Agent 120 or its plugin can establish the MUX channel 330 to cloud VPN 175, such as a data center 350. The agent 120 or plugin can intercept UDP packets 310 from a client application 305, can encapsulate each UDP packet with a header 315 and can forward the encapsulated UDP packet 320 to a cloud VPN 175. The cloud VPN 175 (e.g., server 195) can read the MUX header 315 and forward the encapsulated UDP packet 320 with header 315 to the appropriate data center 350. The agent 120 or plugin can intercept response UDP packets 320 from a MUX channel 330, can decapsulate the encapsulated UDP packets 320 and can forward UDP packets 310 to the intended target application 305, based on the contents of the header 315 of the response packet.

Encapsulated UDP packets 320 can each include a header 315 and a UDP packet 310. Header 315 can include information in addition to the standard information from the standard UDP header of the UDP packet 310. Encapsulated UDP packets 320 can each include information to route the UDP packet across channels.

The MUX Header 315 can include any information to configure the encapsulated UDP packet 320 for routing. Header 315 can include a source internet protocol (IP) address, such as a client 102/165 machine IP address. Header 315 can include a source port, such as the Client Application Source Port. Header 315 can include a destination IP, such as a back-end UDP server 106 IP address. Header 315 can include a fully qualified domain name (FQDN), such as a backend UDP server FQDN. Header 315 can include a destination port, such as the backend UDP Server Port. Header 315 can include a packet type, such as the UDP type or any other packet type if needed to support DNS or ICMP. Header 315 can include a payload length, such as the encapsulated UDP packet length. Header 315 can include a User ID, such as a User ID of the session sending the UDP packet or traffic.

The Multiplex/Mux Channel 330, also referred to as a channel 330, can include a secure connection supporting UDP traffic, such as a TLS or DTLS connection. The UDP packets 310/320 destined from a single client 102/165 to multiple backend UDP Servers 106 can be sent over single MUX channel 330 from the client 102/165 to the cloud VPN 175. The cloud VPN 175 can multiplex incoming UDP network traffic (e.g., encapsulated UDP packets 320 from various clients 102/165) and deliver each encapsulated UDP packet 320 transmitted over one or more channels 330 to the intended UDP servers 106 at one or more data centers 350 on the back-end. Multiplexing can be implemented based on the headers 315 of each of the encapsulated UDP packet 320, which can include the information about the destination to which to be delivered.

Channels 330, whether on the client-side (e.g., between a client and a cloud VPN) or at the back-end (e.g., between the cloud VPN and a data center) can be established based on, or in accordance, with datagram transport layer security (DTLS) protocol. Channel 330 configured based on DTSL protocol can ensure secure UDP communications. Channels 330 can also be established based on, or in accordance with, transport layer security (TLS). For example, client 102/165 can establish and maintain the MUX channel 330 on the client-side as a single TLS MUX channel 330 or a single DTLS MUX channel 330. The client can re-establish the MUX channel 330 if the channel 330 gets terminated unexpectedly while the session is active. In the event that a DTLS-based channel 330 fails, client 102/165 can establish a TLS-based channel 330 with the VPN servers 195 on the cloud VPN 175.

Data centers 350 can include a DMZ that can include any number of computing or network devices at a region or a site. For example, a data center 350 can include servers 106, clients 102 or 165 or any other infrastructure discussed herein. A data center 350 can include or have its devices connected via, a private cloud 175, or a VPN. A data center 350 can include a device or a functionality that identifies devices, such as servers 106 or clients 102/165, to which to forward UDP packets 310 from clients 102/165. Data center 350 can include servers 106 providing service or resources to clients 102/165 over the cloud VPN 175. Data center 350 can include servers 106 combined with VPN servers 195 to provide cloud-based services.

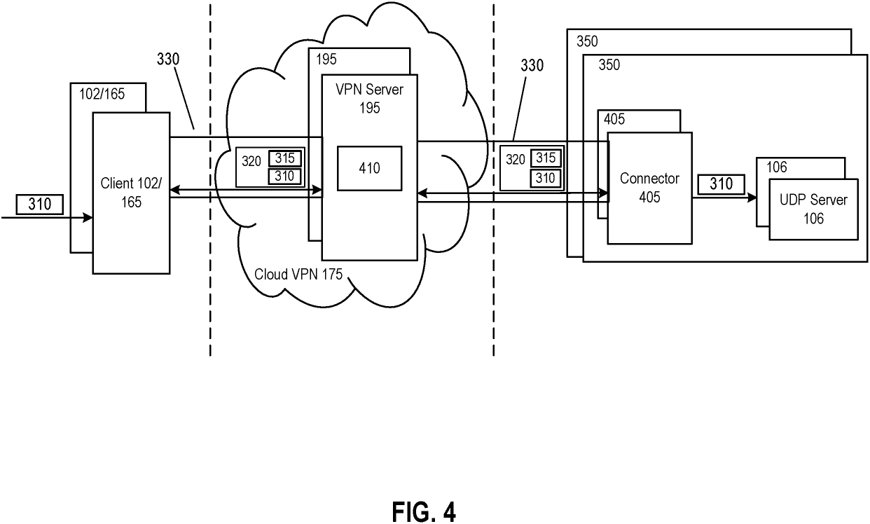

Referring to FIG. 4, an example is shown in which UDP network traffic communication is implemented via client-side channels 330, connecting clients 102/165 with VPN servers 195 of a cloud VPN 175, as well as via back-end channels 330, connecting the VPN servers 195 with the data centers 350. As shown in the example illustrated in FIG. 4, VPN servers 195 operating on a cloud VPN 175 (e.g., cloud 175) can communicate UDP packets 320 to and from clients 102/165 via client-side MUX channels 330, while also communicating UDP packets 320 to and from data center 350 (e.g. DMZs) via back-end MUX channels 330. In particular, VPN servers 195 of the cloud VPN 175 can communicate UDP packets 320 with connectors 405 of the data centers 350. One or more VPN servers 195 can include a lookup table 410 for keeping track of channels 330 established with clients 102/165 and connectors 405 at data centers 350.

A connector 405 can include any device, function, hardware, software or a combination of hardware and software for managing and routing UDP traffic to and from a data center 350. Connector 405 can include an agent, such as an agent 120, and all the functionalities of an agent 120, including the functionality to manage and process UDP packets 310 and 320. Connector 405 can receive encapsulated UDP packets 320, can decapsulate them and based on headers 315 can identify the correct intended destination UDP server 106 to which to forward the UDP packet 310. Connector 405 can include the functionality to encapsulate response UDP packets 310 from UDP servers 106 intended for clients 102/165, can generate headers 315 and can form encapsulated UDP packets 320.

Connector 405 can include any functionality for creating and maintaining channel 330 with VPN servers 195 of the cloud VPN 175. In some implementations, connector 405 forms MUX channel 330 with servers 195. In some implementations, a cloud VPN 175 (e.g., servers 195) can establish and may maintain a MUX channel 330 based on TLS/DTLS with one or more connectors 405 in various data centers 350 and can deliver the UDP packet 320/310 to the appropriate connector 405 at the appropriate data center 350. The MUX channel 330 with connector 405 can be referred to as the backend server-side MUX channel 330. The connector 405 can establish backend server-side MUX channel 330 and can deliver UDP packets 320/310 to the intended destination UDP servers in data center 350.

Connector 405 in a data center 350 can register itself with cloud VPN 175. Connector 405 can establish aa persistent outbound connection to cloud VPN 175 for a control path. When the cloud VPN 175 seeks to establish MUX channel 330 with a specific data center 350, the cloud VPN 175 can send the request for MUX channel 330 establishment to the connector 405 in the specific data center 350 via persistent control path connection. The connector 405 can establish a new outbound connection with cloud VPN 175 for data path. The new data path connection can be used and maintained as MUX channel 330 by cloud VPN 175. The connector 405 can also decapsulate the UDP packets 320 received over MUX channel 330 and can deliver them to appropriate intended destination UDP server 320 based on the MUX header 320 destination. The response UDP packets 310 from the destination UDP server 310 can be encapsulated and handed over to the correct backend server-side MUX channel 330 by connector 405. The cloud VPN 175 (e.g., VPN server 195) can deliver the encapsulated response UDP packet 320 to the correct client-side MUX channel 330 to be delivered to the intended client 102/165. Then, the encapsulated response UDP packet 320 can be received by the agent 120 or plugin of the client 102/165 and delivered to the intended application 305.

A lookup table 410 can include any type of a table, data structure or a sorted or organized information corresponding to channels 330. Lookup table 410 can include information about channels 330 and devices between each channel 330 is established. Lookup table 410 can identify one or more channels 330 along with devices between which each channel 330 is established (e.g., client 102/165, VPN server 195 and/or particular connector 405). Lookup table 410 can include any information on connectors 405 and/or clients 102/165 with which channels 330 can be established.

As shown in the example in FIG. 4, in one implementation, a client-side MUX channel 330 can be formed between a client agent 120 (e.g. client’s plugin) and cloud VPN 175, such as for example, between the client agent 120 on a client 102/165 and a VPN server 195 on the cloud VPN 175. A back-end MUX channel 330 can also be formed between a cloud VPN 175 (e.g., VPN server 195) and the connector 405 of a data center 350 (e.g., the backend or server-side MUX channel 330). The client-side MUX channel 330 can be established while an end user is logging-in to the client 106 device or agent 120 (e.g., a client’s plugin). The client agent 120 (or its plugin) can intercept the UDP packets 310 from various client applications 305 and can process the UDP packets in real time. The client agent 120 (e.g., plugin) can determine whether the UDP packets 310 are to be encapsulated and forwarded to cloud VPN 175 (e.g., VPN servers 195) by matching the configured destination for user at a server 195 of the cloud VPN 175.

The client agent 120 or plugin can expect/detect/intercept the UDP response packets 320 from the UDP servers 106, received from cloud VPN 175 175 (e.g., servers 195) to also include the UDP packet 310 that is be encapsulated with MUX Header (e.g., 315). The header 315, such as the header 315 of the response encapsulated UDP packet 320, can include the client application’s source port to identify the application 305 to which the received packet is to be forwarded. Once received and decapsulated, the client agent 120 or plugin can hand over the response (e.g., UDP packet 310) to the correct client application 305 based on the header 315.

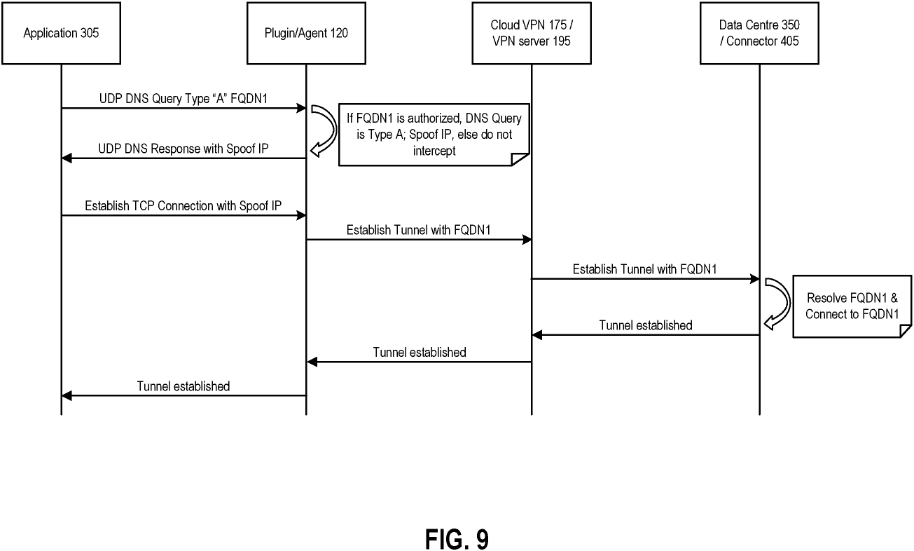

As an example, routing of UDP packet from a client 102/165 to a destination server 106, and vice versa, can be done using agent 120 or a plugin, any software 180, platform 185, infrastructure 190 or servers 195 on the cloud VPN 175, a connector 405 at destination data center 350 and the destination server 106 at the destination data center 350. A client 102/165 can include a client agent 120, or a plugin, to establish a dedicated TLS/DTLS based client-side MUX channel with cloud VPN 175. This can be implemented in response to the login by the user to the agent 120 or the plugin, or the application utilizing client agent 120. The cloud VPN 175 can utilize any software 180, platform 185, infrastructure 190 or server 195 to accept the client-side MUX channel request from client and maintain the connection. The client-side channel 330 can therefore be established and maintained. The client agent 120 can intercept one or more UDP packets 310 from client applications 305. If a UDP packet 310 destination is configured for user, service or resource in a cloud VPN 175, agent 120 can encapsulate the intercepted UDP packet 310 with header 315 to form an encapsulated UDP packet 320. Agent 120 can forward the packet 320 over the client-side MUX channel to the device on the cloud VPN 175 (e.g., VPN server 195) with which the channel 330 is established. On receiving the encapsulated UDP packet 320 from the client-side MUX channel 330, the cloud VPN 175 (e.g., VPN server 195) can parse the MUX header 315 and can identify the destination data center 350 out of any number of data centers 350 to which to forward the encapsulated UDP packet 320. Identifying the data center 350 and the connector 405 to which to forward the UDP packet 320 can be done in accordance with, or together with, acts or steps illustrated for example in FIG. 9.

FIG. 9 provides an example of a process for implementation of UDP DNS in which Spoofing IP address for DNS resolution can be used, such as for example for Type A or AAAA records. In FIG. 9, a UDP DNS Query Type “A” FQDN1 can be sent to agent 120 or plugin at the client. If FQDN1 is authorized, DNS Query is Type A and IP can be spoofed (e.g., a new IP address can be generated to hide the private IP address of target server or receiver). The agent 120 (e.g., plugin) can reply back to the application a UDP DNS response with spoof IP address. The application can then establish a TCP connection with the spoof IP address (e.g., agent 120 or plugin). The agent 120 can then establish tunnel with FQDN1 with the cloud VPN 175 or its VPN server 195. The cloud VPN (e.g., VPN server 195) can establish a tunnel with FQDN1 to the data center 350 (e.g., connector 405). These two tunnels can be established using DTLS/TLS, for example and can include channels 330. At the data center 350, FQDN1 can be resolved by connector 405 or a destination server and a connection can be made to the FQDN1 (e.g., destination, such as a server 106, identified by FQDN1). A tunnel between the data center 350 and the VPN server 195 can be established for a return traffic, and another tunnel between the VPN server 195 and the agent 120 of the client 120 can be established. The tunnel can then be established from the tunnel from the agent 120 of the client to the application 305.

Cloud VPN 175 can determine if a backend server-side MUX channel 330 is established with the destination data center 350. This determination can be done by a VPN server 195 using a lookup table 410 which can include information on channels 330 formed with various data centers 350. If the backend server-side MUX channel 330 already exists for the particular destination data center 350, according to the lookup table 410, VPN server 195 can forward the encapsulated UDP Packet 320 to that data center 350. If the backend server-side MUX channel 330 does not exist for the destination 350 data center in lookup table, the cloud VPN 175 can request the connector 405 to establish a backend server-side MUX channel via the persistent control path connection. Once the backend server-side MUX channel 330 is established with the connector 405, the cloud VPN 175 can update backend server-side MUX channel 330 to the lookup table 410 with data center 350. VPN server 195 can then forward the encapsulated UDP packet 320 over the backend server-side MUX channel. Connector 405 of the destination data center 350 can receive the encapsulated UDP packet 320 and decapsulate and forward the UDP Packet 310 from the decapsulated packet 320 to the destination UDP server 106 based on destination information in the MUX Header 315 of the UDP packet. In some implementations, the connector 405 can forward the packet 320 along with the header 315 to the destination UDP server 106.

Connector 405 can receive a response from the destination UDP server 106 for the client application 305 on the client device 102/165. The response from UDP server 106 can include a UDP packet 310 that can be encapsulated by the connector 405 into UDP packet 320 and forwarded through the same backend server-side MUX channel 330 through which a prior UDP packet from the same client 102/165 was received. The cloud VPN 175 can receive the encapsulated response UDP packet 320 from the connector 405 and can parse the MUX header 315 for details on the intended client 102/165. Cloud VPN 175 can find the client-side MUX channel 330 based on the client details and can forward the encapsulated UDP response 320 to the client 102. Cloud VPN 175 (e.g., VPN server 195) can identify the channel 330 for the client 102 to which to forward the response encapsulated UPD packet 320 based on the lookup table 410. For example, information from header 315 of the encapsulated response UDP packet 320 can be compared with information in the lookup table 410 to identify the correct channel 330 (e.g., DTLS/TLS channel) for the intended destination client 102/165. Once the client 102/165 receives the encapsulated response UDP packet 320, the Client 102/165 can decapsulate and forward the response packet to the client application 305, based on the details on/in the MUX header 315, such as for example details identifying the application 305 or the session of the application 305.

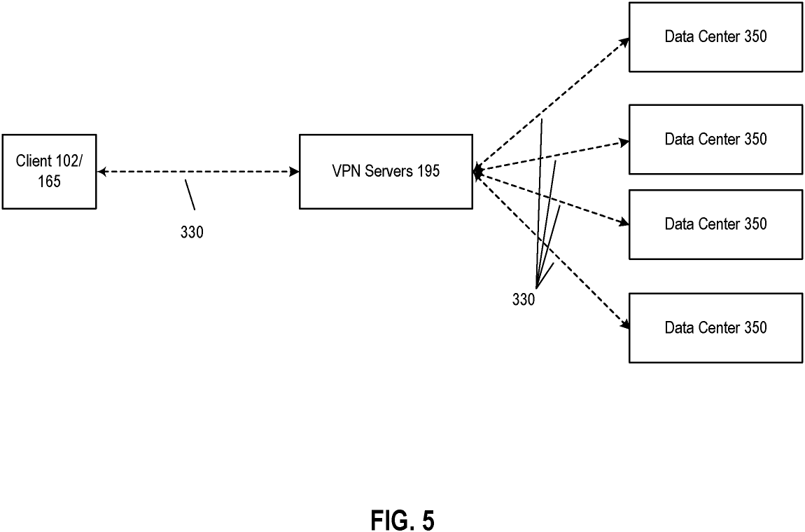

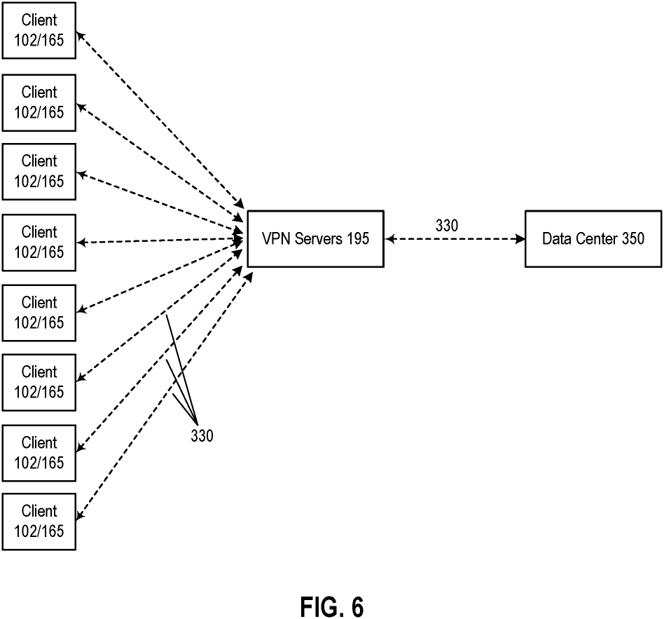

Referring now to FIGS. 5 and 6, embodiments in which VPN servers 195 on the cloud 175 can encounter many client-side channels 330 or many server-side channels 330. Such instances can lead to network challenges due to channels 330 being overloaded. For example, in FIG. 5, an embodiment is illustrated in which multiple data centers 350 can communicate UDP network traffic over many back-end channels 330 to a single client 102/165. This arrangement can, in some instances, lead to a potential overload of the client-side channel 330.

In FIG. 6, for example, an embodiment is illustrated in which multiple clients 102/165 can utilize multiple client-side channels 330 to access a single data center 350 via a single back-end channel 330. Just as with the example in FIG. 5, the example in FIG. 6 can also result in an overloaded channel 330, this time a back-end channel 330 to the data center 330. The present solution addresses these and other similar issues by providing pools of connections and fallback mechanisms for re-establishing channels 330 as desired.

A channel 330, such as a back-end or server-side or a client-side channel 330, can be terminated due to any number of network/server issues. In such instances, the client 102/165 can re-establish the client-side channel 330. Similarly, the cloud VPN (e.g., VPN server 195) can re-establish the backend server-side channel 330 with the connector 405 of the data center 350. In case that many clients 102/165 (e.g., hundreds or thousands) send the UDP packets to a single data center 350 via a single backend server-side MUX channel 330, the backend server-side channel can be overloaded and can become a performance bottleneck. To resolve this, and similar channel bottleneck issues, a VPN server 195 of the cloud VPN 175 can create a pool of connections to be used for these situations, as needed. The pool of connections can be scaled up/down based on the load or number of clients 102/165 that can be connecting to the data center 350. The authorizations for the pool of connections can be cached for a brief period, such as 5, 10, 15, 45 or 60 minutes. This can avoid calling an authorization function for each UDP packets that is to be transmitted.

The client-side channel 330 and a backend server-side channel 330 can be either TLS based or DTLS based. For example, TLS can be a TCP based protocol, whereas DTLS can be a UDP based protocol. The MUX channel 330 can be established using a DTLS channel over TLS. DTLS channel over TLS can improve the performance of communication of UDP traffic over the cloud VPN 175. The TLS can also be used over a TCP protocol. While doing so can create latency, TLS over a TCP can be implemented, for example, when TCP reliability is prioritized.

DTLS channel can encounter one or more issues. For example, a DTLS handshake can be blocked if there is proxy in a customer data center 350. Also, some customer data centers 350 may not open outbound UDP traffic, and this can cause DTLS handshake related issues, such as a handshake failure for example. Also a client can fail to establish a DTLS handshake due to proxy/firewall/authorization blocking communication. To overcome these and other issues, the present solution can provide an option of a DTLS to TLS fallback, which can be supported by both client and the connector 405. In doing so, both the front-end (e.g., client to cloud VPN 175) and back-end (e.g., cloud VPN 175 to connector 405) channels 330 can support DTLS and TLS and can further include the functionality for providing a fallback from DTLS to TLS, in the event that DTLS cannot be established. This can be useful, for example in the examples in FIGS. 5 and 6, where in the event of channel 330 failure, a backup channel 330 can be established (e.g., TLS in the event that a DTLS fails or is strained).

Client agent 120 (e.g., a plugin) can attempt to establish a DTLS channel 330 by trying DTLS handshake for UDP traffic. However, in case of failure of establishing a DTLS channel, the system can establish a TLS channel 330 with cloud VPN 175. If client agent/plugin (e.g., 120) succeeds in establishing DTLS channel, it may not establish a TLS channel, but may rather use DTLS channel 330. For example, on the backend, when cloud VPN 175 requests for DTLS MUX channel 330 for UDP traffic, the connector 405 can try establishing a DTLS channel 330 by implementing a DTLS handshake. In the event that the DTLS handshake is not implemented, the connector 405 can establish TLS channel 330 with cloud VPN 175. If connector 405 succeeds in establishing DTLS channel, the TLS channel may not be established and only a DTLS channel can be used. A connector 405 can establish only a single channel with the cloud VPN 175 and this channel can be dedicated to UDP traffic.

On receiving the response from a backend server-side channel (e.g., channel between connector 405 and cloud VPN 175), the connector 405 can send the UDP packets of the response to the same client-side channel from which it received the UDP packets from the client. If the request is received in client side DTLS channel and while forwarding response, the DTLS connection can be terminated and the response can be sent over TLS channel.

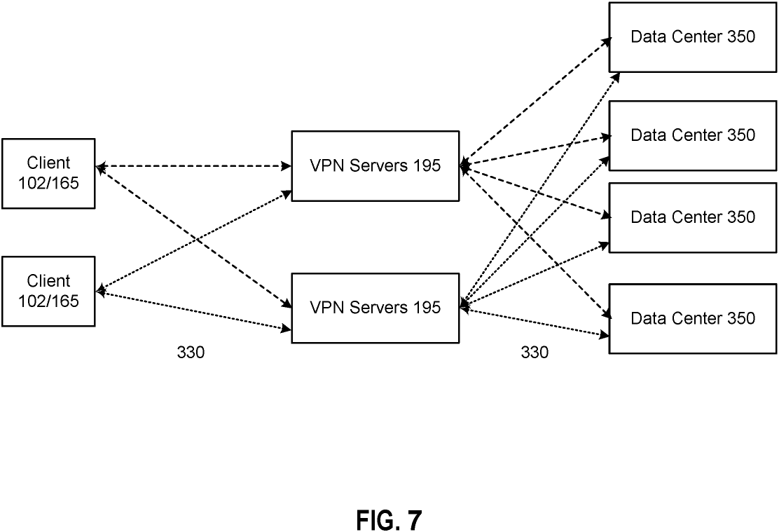

FIG. 7 illustrates an embodiment in which multiple clients 102/165 exchange network traffic (e.g., UDP packets 320) with remote data centers 350 via client side channels 330 between clients and VPN servers 195 and back-end channels 330 between VPN servers 195 and data centers 350. As shown in FIG. 7, each client 102 can establish a client-side channel 330 with each VPN server 195 of the cloud VPN 175. Similarly, each VPN server 195 of the plurality of VPN servers 195 of the cloud VPN 175 can establish a back-end channel 330 with each of the data centers 350. If a client 102/165 sends a UDP packet 320 to a first data center 350 via a first VPN server 195, the UDP packet can be encapsulated and sent by the client 102/165 over a first client-side channel 330 to a first VPN server 195. From the first VPN server 195, the same encapsulated UDP packet can be sent via a first back-end side channel 330 to the first data center 350 to which the first packet is intended. If a client sends another UDP packet 320 to a second data center 350 over the same first VPN server 195, the UDP packet 320 can be sent via the same first channel 330 (as the first UDP packet) to the first VPN server 195 and then from the first VPN server 195 it can be sent via a second back-end channel 330 to the second data center 330. Therefore, multiple UDP data packets 320 from a client 102/165 can be sent to the same VPN server 195 via the same client-side channel 330, while to the extent the UDP data packets are directed to different data centers 350 then different back-end channels 330 can be used.

Conversely, in terms of the return UDP traffic from the data centers 350 to multiple clients 102/165, a data center 350 can use the same back-end channel 350 for all UDP traffic to the same VPN server 195 and from that VPN server 195 multiple client-side channels 330 can be used for multiple clients 102/165.

In some implementations, a client 102/165 can use a first VPN server 195 to direct a first UDP packet 320 to a first data center 350 and use a second VPN server 195 to direct a second UDP packet to the first data center. In doing so, the client 102/165 can avoid utilizing the same client-side or backend channel 330 twice to avoid burdening one of the channels 330 more than others and load balance.

In some aspects, the present solution relates to systems and methods of a cloud VPN 175 routing traffic to target or intended machines (e.g., servers 106) in a distributed customer data center 350 based on a routing table. The routing table can be used to identify destinations of the UDP network traffic based on IP/FQDN/Domain information of customer data centers.

Cloud VPN 175 can provide access to private servers 106 in distributed customer data centers 350 for clients 102/165 in a public network. A customer, such as an enterprise, can include multiple data centers 350 registered with cloud VPN 175. In such a system, it may be desirable to route a request from a client to the correct customer data center 350. The routing can be based on which private server 106 in a customer data center 350 the client is requesting to access or to which server 106 the client is trying to connect. For example, the client 102/165 may try accessing the private server in the customer data center using private IP address or private FQDN (Fully Qualified Domain Name). When relying on private IP addresses or private FQDN that are unique to a particular data center 350, but not all data centers 350 or all devices on the network 104, routing UDP traffic or requests can be challenging.

In some examples, a customer data center can have a number of private servers 106. In some examples, private servers can be distributed across multiple customer data centers in several regions. A customer can have different IP ranges and FQDNs assigned to different private servers 106. In such instances, the cloud VPN 175 can be aware of IP addresses of machines located in one or more customer data centers, whereas some machines or servers 106 from one region may not be aware of IP addresses or FQDNs of servers 106 or machines from other regions. For example, a network device (e.g., client 102/165, server 106, server 195 or any other device discussed herein) may be aware of IP addresses or FQDNs of network devices in one data center 350, but not be aware of IP addresses or FQDNs in other data centers 350. Therefore, when UDP packets are directed to some network devices to which routing network devices do not know IP address or FQDN, the UDP packet can be lost or dropped.

In the instances in which on-premises VPN routes data packets locally, there may not be a challenge of routing as the VPN is located inside of a DMZ of the customer data center and the target machines can be in the same data center. In such instances, all the routing network devices can be aware of the IP addresses and FQDNs of the target devices, thereby ensuring that UDP packets are not dropped. However, when requests or UDP traffic is directed to private IP addresses or private FQDN via cloud VPN 175 and private servers 106 are distributed across different customer data centers 350 spanned across several regions, the network traffic may not be properly delivered as private IP address or private FQDN may not be identified.

To resolve these and similar issues, cloud VPN 175 can provide access to private servers 106 in distributed customer data centers 350 for the clients 102/165 on the network 104 (e.g., public network 104, cloud 175, etc.). The client 102/165 can try accessing the private server in customer data center using a private IP address or private FQDN. A customer data center can have hundreds of servers with a wide range of IP, domain, ports. Each private server destination in a customer data center can be configured for cloud VPN 175 to include a destination server IPs/domains configuration having an IP or IP Range or IP CIDR, or a FQDN or wild-card Domain. Cloud VPN 175 can be configured to include a Destination Server Port configured as a single or group of port numbers. Cloud VPN 175 can be configured to include a destination protocol to be configured as TCP or UDP. The private servers can be any type of servers, such as TCP or UDP servers. The private servers can be DNS or HTTP servers. The routing problem can be a common problem for all types of servers.

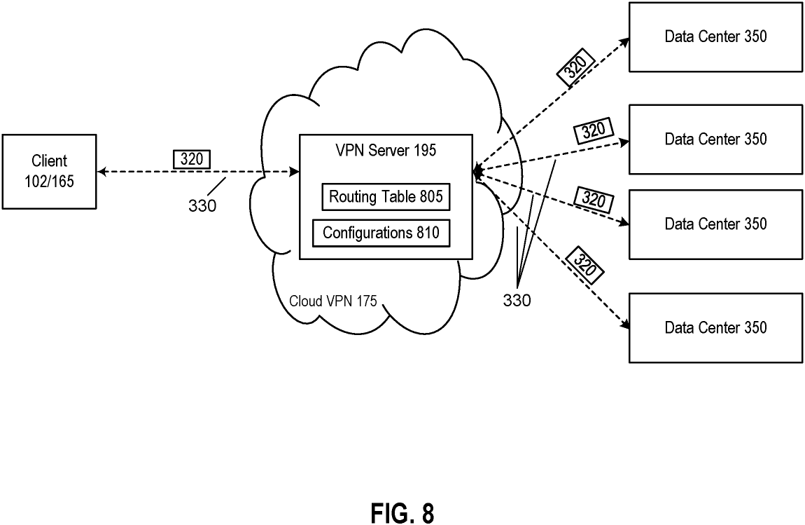

FIG. 8 illustrates an example embodiment in which a VPN server 195 of a cloud VPN 176 includes a routing table 805 for routing the UDP traffic between the one or more clients 102/165 and one or more data centers 350. More specifically, VPN server 195 can utilize the routing table 805 to match information from the UDP packets 320 transmitted between the one or more clients 102/165 and one or more data centers 350 via client-side and back-end side channels 330. VPN server 195 can identify destinations of the UDP packets 320 based on the information stored in the routing table 805 and the information stored in the headers 315 of the encapsulated UDP packets 320. VPN server 195 can configure network devices on the data centers using configurations 810.

A routing table 805 can include any information for identifying destinations of encapsulated UDP packets 320 using information from a header 315. An example of a routing table 805 can include Table 1 below. As shown in Table 1, a routing table 805 can include information on category of network devices, such as server 106 identifying, for example, TCP servers 106 and UDP servers 106. Routing table 805 can include information on how each server 106 can be accessed, such as information identifying IP addresses or ports that can be used to access the server 106 or other network device. Routing table 805 can include an identifier of a network device or a service on cloud 175, such as an IP address or a hostname of a server 106 or server 195. Routing table 805 can include information on a port to access a network device, such as a port number of a server 106 or server 195. Routing table 805 can include a protocol for communicating with the server 106 or a network device. Routing table 805 can include any information, such as for example, information shown in Table 1 for private server 106 configuration or setup, as shown below:

TABLE1

Examples of private server configuration

| Category | Destination Example | IP Addresses / Hostnames | Port | Protocol |
|---|---|---|---|---|
| TCP Servers | A TCP server can be accessed using IP address & Port | 10.10.10.105 | 13456 | TCP |
| | Group of TCP Server can be accessed using range of IP address | 10.10.10.150 to 10.10.10.250 | 13456 | TCP |
| | Group of TCP Server can be accessed using range of IP addresses and group of Ports | 10.10.10.150 to 10.10.10.250 | 13456, 13488, 2234 | TCP |
| | A TCP server can be accessed using | App1.exampleserver.com | 1456 | TCP |
| | FQDN & Port | | | |
| | Group of TCP server can be accessed using FQDN from wild card Domain & Port | *.eng.exampleserver.com | 1345 | TCP |
| | Group of TCP server can be accessed using FQDN from wild card Domain & Group of Port | *.eng.exampleserver.com | 13451, 13481, 2231 | TCP |
| UDP Servers | A UDP server can be accessed using IP address & Port | 10.10.10.105 | 13456 | UDP |
| | Group of UDP Server can be accessed using range of IP address | 10.10.10.150 to 10.10.10.250 | 13456 | UDP |
| | Group of UDP Server can be accessed using range of IP addresses and group of Ports | 10.10.10.150 to 10.10.10.250 | 13456, 13488, 2234 | UDP |
| | A UDP server can be accessed using FQDN & Port | App1.exampleserver.com | 1456 | UDP |
| | Group of UDP server can be accessed using FQDN from wild card Domain & Port | *.eng.exampleserver.com | 1345 | UDP |
| | Group of UDP server can be accessed using FQDN from wild card Domain & Group of Port | *.eng.exampleserver.com | 13451, 13481, 2231 | UDP |

Routing table 805 can include a wide range of flexible options for customer admin to group or configure servers 106/195, such as private application servers 106/195 in a customer data center 350. For example, each private server 106 with one unique IP address and port in backend can be an application server 106. In some cases, multiple private IP servers with group of IP address with one port number can act as application server (e.g., like replicas). In some cases, multiple private IP servers with group of IP addresses and/or with group of port number can act as application server 106 for client 102/165. The client application can navigate across private server to provide access to end user.

Configurations 810 can include any configurations of network devices, such as servers 106 at data centers 350. Configurations 810 can include one or more configuration objects. A configuration object can be created based on one or multiple private TCP/UDP Servers with IPs/FQDNs/wildcard domain, Port and Protocol can be referred to as a configuration 810. Configuration 810 can include a group of TCP/UDP servers 106 configured together into or as a configuration object. Configuration 810 can include or correspond to a group of TCP servers 106 and/or UDP servers 106 for Cloud VPN and can include any combination of destinations examples provided as examples in Table 1. Configuration 810 of a group of TCP/UDP servers 106 can have any one or more, or all of: a protocol, a single IP, a port, an IP range/CIDR, a group of ports, a single FQDN or a wildcard domain. For example, a configuration 810 can include a single IP, a port and a protocol. Configuration 810 can include an IP range/CIDR, group of ports and a protocol. Configuration 810 can include a single FQDN, port and protocol. Configuration 810 can include a wildcard domain, group of ports and protocol.

When the client requests access or sends traffic to one of the private machines IP/FQDN, the cloud VPN 175 can control the access based on a policy of the configuration 810. Cloud VPN 175 and its devices or services can know to which one of the distributed customer data centers the traffic should be forwarded after access is allowed.

To address the routing decision, the cloud VPN 175 can have a routing table 805 to map IP/FQDN to distributed customer data center 350 network. The routing table 805 can have the routing entries for single/group of destinations to a data center 350 mapping. The Routing table can be configured by customer IT admin while adding multiple destinations for configuration 810. For example, as below IP/FQDN/Domain can be mapped to data center ID, as follows:

| | |
|---|---|
| IP/IP range/ FQDN/ Wildcard Domain | Data Center Unique ID |

Each customer data center 350 can have a display name for customer admin to choose and map to the destinations. The display name can be for human readability purpose. Each customer data center 350 can be identified by unique ID. The data center 350 can be registered with cloud VPN 175 and register himself with unique ID. The unique ID generation for each data center 350 can be initiated by customer data center 350 using an agent 120, which can be deployed on any network device in a data center 350 and can be referred to as a connector 405.

Each table entry in the routing table 805 can have destination information, such as those listed in the examples in Table1, as well as a data center 350 identifier. There can be a possibility that the exact same Single IP/IP Range/Single FQDN/Wildcard Domain can be configured multiple configurations 810. For example, in the below table (Table2), a first configuration 810 (e.g., App1) and a second configuration 810 (e.g., App2) can have the same destination in same data center 350 but bound different policy & group. For instance, the same destination can have different policy for different group of users.

TABLE2

Two different Application having same destination

| | | | |
|---|---|---|---|
| Application name | Destinations | Target Datacenter | Policy |
| App1 | 10.10.10.100 to 10.10.10.200 | datacenter1 | Policy1 assigned for group 1 |
| App2 | 10.10.10.100 to 10.10.10.200 | datacenter1 | Policy2 assigned for group2 |

In the above Table2, configurations 810 (e.g., App1 and App2) can be configured with same destination and the client 102/165 network traffic can be routed to same customer data center 350 as target machines can be same. In the above scenario, the routing table 805 can have a single entry for the destination ‘10.10.10.100 to 10.10.10.200’ for both App1 and App2, as opposed to two entries, since these two configurations 810 can be different. In some implementations, the routing table can have entry based on the destination and not based on the configurations 810.

The routing table 805 can include a common global table for the destination servers (IP/FQDN/Wild card domain) which can be configured while adding configurations 810 for a customer.

Example of common Routing Table 805 entries are as below.

TABLE3

Example Types of Routing table entries

| Destinations | Customer datacenter |
|---|---|
| 10.10.10.100 to 10.10.10.200 | Datacenter1 |
| *.exampleserver.com | Datacenter2 |
| Myserver.exampleserver.com | Datacenter2 |
| 10.10.20.13 | Datacenter3 |

The routing table 805 entries in Table 3 can be added for each destination (e.g., single IP/IP range/ single FQDN/domain) addition when creating the Application (TCP/UDP Server Group). For each destination added as part of the configuration 810, (e.g., TCP/UDP Server Group), the data center 350 mapping can be chosen for Routing table 805. The chosen destination to data center 350 mapping can be added to common Routing Table 805 along with creating configurations 810. The IP address for the machines can be unique across the data centers 350 of a customer. The client 102/165 can use the unique private IP address of a machine to gain access to the machine.

As the routing table 805 can be common/global and IP ranges and wildcard domains can be added to the table, the entries can have conflicts if one or more entries (e.g., added by different configuration 810) in a routing table 805 have overlap IP ranges or domains for the same/different data centers 350. In turn, this can create routing conflicts.

The routing conflicts can be resolved by the customer IT admin to avoid cloud VPN 175 getting to the state where it cannot decide (or incorrectly decide) which data center 350 the traffic should be forwarded. Such entries can then be used to route network traffic accordingly.

In one example, two configuration 810 can be configured with same destination information. As the same destination data may not be allowed in two data centers 350, the configuration 810 (e.g., App2) can be overwritten so that it is placed in a different data center (e.g., from Datacenter1 to Datacenter2) to resolve the exact conflict/match of destinations issue, as shown in the example below:

| | | |
|---|---|---|
| Type | Entry | Datacenter |
| App1 | 10.10.10.0 to 10.10.10.255 | Datacenter1 |
| App2 | 10.10.10.0 to 10.10.10.255 | Datacenter2 |

For example, two configurations 810 can be configured with subset overlapping destinations. For example, as shown in the example below, as App2 chooses Datacenter2 for subset of existing IP range, it can create a conflict for VPN servers 195 in cloud VPN 175 to decide whether to forward to datacenter1/datacenter2 for overlapping IP addresses. This conflict can be resolved by customer IT admin, as shown in the example below:

| | | |
|---|---|---|
| Type | Entry | Datacenter |
| App1 | 10.10.10.0 to 10.10.10.255 | Datacenter1 |
| App2 | 10.10.10.50 to 10.10.10.60 | Datacenter2 |

For example, two configuration 810 can be configured with partial overlapping destinations. As App2 chooses Data center2 for partial overlapping to existing IP range, it creates conflict for cloud VPN 175 to decide whether to forward to data center1/data center2 for overlapping IP addresses. This conflict can be resolved by a customer IT admin for instance.

| | | |
|---|---|---|
| Type | Entry | Datacenter |
| App1 | 10.10.10.0 to 10.10.10.100 | Datacenter1 |
| App2 | 10.10.10.50 to 10.10.10.200 | Datacenter2 |

For example, an example of a domain conflict in routing table 805 is shown below. Two configurations 810 can be configured with same destinations domains. As the same destinations may not be in two data centers 350, the App2 can overwrite the Datacenter to Datacenter2 in case of exact conflict/match of destination.

| | | |
|---|---|---|
| Type | Entry | Datacenter |
| App1 | *.eng.example.com | Datacenter1 |
| App2 | *.eng.example.com | Datacenter2 |

In one example, two configuration 810 can be configured with subset overlapping destinations. For example, as App2 chooses Datacenter2 for subset of existing Domain, it can create a conflict for cloud VPN 175 to decide whether to forward to datacenter1/datacenter2 due to overlapping Domain. This conflict can be resolved by customer IT admin.

| | | |
|---|---|---|
| Type | Entry | Datacenter |
| App1 | *.eng.example.com | Datacenter1 |
| App2 | *.example.com | Datacenter2 |

The above example conflicts can be resolved by customer IT administrator. Once the settings are established, the system may then perform UDP routing, based on the updated configuration 810 corresponding to, or within the, routing table 805.

In case of conflict entries in routing table 805 are not resolved by customer IT admin, the cloud VPN 175 behavior can be designed with one or more options. For example, the entry which has the smallest range of overlapping destinations can be chosen. This may work well for domain-based destinations as subdomain can be the smallest range, which can narrow the source of errors. This option can be implemented for Citrix Cloud VPN. For example, the recently added/modified routing table entry’s data center can be chosen. In this case, the recently added/modified can be the latest network status as per customer IT admin.

There was no previous solution for cloud VPN 175 for routing traffic with routing table entries for data center. The routing table was being used for general routing purposes for IP layer (Layer 3) of TCP/IP layers in machines and Layer 3 routers. The Layer 3 routing table helps with routing IP packet traffic in layer 3. The cloud VPN 175 routing table can be used for routing to customer data centers.

The present solution can be used for cloud VPN 175 (e.g., VPN servers 195) to route traffic (e.g., UDP packets 320) to distributed multi region customer data centers 350 based on client accessing destination IP address or FQDN to data center 350 mapping entries from global routing table 805. The IP address or FQDN can have direct mapping entry or can be subset of wider range of IP address mapping entry or wild card Domain mapping entry. The routing table 805 can be global configuration for a customer and his distributed data centers. The IP conflict and domain conflict with multiple data centers can be resolved to avoid ambiguity for cloud VPN 175 while routing the traffic.

Referring now to example embodiments in FIGS. 3-8, the present solution can relate to a system for handling network traffic between the clients and various data centers, via a cloud VPN. The system can include an agent 120 executing on a processor of a client device (e.g., 102/165) that can be coupled to memory. The agent 120 can include a plugin. The agent 120 can receive a user datagram protocol (UDP) packet (e.g., 310). The agent can generate a header for the UDP packet (e.g., 315). The header can identify a destination server (e.g., 106) at a data center (e.g., 350) of a plurality of data centers that can be dispersed on various locations. The agent 120 can establish a channel to a virtual private network (VPN) server (e.g., 195) of a cloud-based VPN. The VPN server can be a part of a cloud VPN as a service. Agent 120 can encapsulate the UDP packet (e.g., 310) using the header (e.g., 315) to form an encapsulated UDP packet (e.g., 320). Agent 120 can transmit, via the channel, the encapsulated UDP packet (e.g., 320) to the VPN server (e.g., 195). The encapsulated UDP packet (e.g., 320) can be configured to identify the data center 350 of a plurality of data centers according to, or based on, a table of the VPN server (e.g., 805) and/or content of the header (e.g., 315).

The encapsulated UDP packet can be configured to identify, based on the table of the VPN server (e.g., 805), a connector 405 of the data center 350 to which to forward the encapsulated UDP data packet. The agent can receive the UDP packet to encapsulate from an application (e.g., 305). The application (e.g., 305) can be on a client (e.g., 102/165) or remote from the client device. The agent (e.g., 120) can establish the channel (e.g., 330) to the VPN server using one of a datagram transport layer security (DTLS) or a transport layer security (TLS). The agent (e.g., 120) can generate the content of the header (e.g., 315) so that the header identifies the client device (e.g., 102/165), the destination server (e.g., 106) at a data center 350, a length of the encapsulated UDP packet (e.g., 310 and/or 320) and/or an identification of the user session or connection to which the UDP packet corresponds.

The agent 120 can further receive a second UDP packet (e.g., 310). The agent can generate a second header (e.g., 315) for the second UDP packet (e.g., 310). The second header can identify a second destination server (e.g., 106) at a second data center (e.g., 350) of the plurality of data centers. The agent 120 can encapsulate the second UDP packet using the second header and form encapsulated second UDP packet (e.g., 320). The agent 120 can transmit, via the channel, the second encapsulated UDP packet to the VPN server (e.g., 195). The second encapsulated UDP packet (e.g., 320) can be configured to identify the second data center (e.g., 350) according to, or based on, the table of the VPN server (e.g., 805) and content of the second UDP header.

The agent 120 can receive a UDP domain name system (DNS) query from an application (e.g., 305), which can be on the client device. The agent 120 can transmit, to the application (e.g., 305), a UDP DNS response using a first internet protocol (IP) address. The first IP address can be a spoof/defined IP address, which can mask the actual identity of the agent 120 to the application 305. The agent 120 can then receive the UDP packet via a TCP connection established between the application and agent using the first IP address.

The encapsulated UDP packet (e.g., 320) can be configured for a connector (e.g., 405) of the data center (e.g., 350) to identify the destination server (e.g., 106) of a plurality of destination servers 106 of the data center 350. The agent 120 can receive, from the VPN server (e.g., 195) via the channel (e.g., 330), a second encapsulated UDP packet (e.g., 320) comprising a second UDP packet (e.g., 310) sent from the destination server (e.g., 106) to an application (e.g., 305) of the client device. The agent 120 can decapsulate the second encapsulated UDP packet to extract the second UDP packet and transmits the second UDP packet to the application. The agent 120 can identify the application according to a second header (e.g., 315) of the second encapsulated UDP packet (e.g., 320) from the destination server 106.

In some aspects, the present disclosure relates to systems and methods for DNS name resolution by DNS server distributed across customer data centers 350 via cloud VPN 175. For example, a client application can use a DNS resolution from FQDN to IP address before establishing a TCP connection or sending a UDP request to a destination server 106 that is not located behind a VPN. In case of VPN, the both on-premise VPN and cloud VPN 175 solution should support remote DNS name resolution with DNS server in customer data center 350 along with providing TCP/UDP access to remote private servers in customer data centers.

With respect to on-premise VPN, if the private machines/servers are in remote customer data center, the on-premise VPN (SSL) in customer DMZ network can provide access for clients 102/165 in public network (e.g., 104). The private machine/servers 106 can be accessed either using IP address or FQDN by client 102/165. If the private machines are accessed using FQDN/Hostname, the DNS name can be resolved with DNS server in customer data center 350 by on-premise VPN.

The cloud VPN 175 (SSL) solution can provide VPN tunnel access to private machines and servers 106 in customer data centers 350 for clients in public network 104. The TCP/UDP traffic can be tunneled over cloud VPN 175 to customer data center. The private machine/servers can be accessed either using IP address or FQDN by client 102/165. In case when a client 102/165 tries to access/connect to private server using FQDN, the FQDN can be DNS name resolved remotely through the DNS server in customer data center 350 before accessing/connecting. A customer can have multiple data centers 350 accessible through cloud VPN 175 and the DNS server (e.g., 106) can be distributed across data centers 350.

The DNS Name resolution for the private machines in distributed customer data center 350 via multi-tenant cloud VPN 175 can have some challenges. For example, in distributed customer data center 350 environment where cloud VPN also in multiple regions, the client 102/165 resolving the DNS hostname remotely via cloud VPN with DNS server in customer data center 350 can add additional latency. The latency can slow the communication and adversely affect the user experience. Also, a DNS name resolution should not be performed remotely in customer data center 350 if the user is not authorized to resolve the domain. Doing otherwise may compromise security. In another example, a DNS query packets can be sent over UDP generally, while some client applications may prefer to send traffic over TCP. If a DNS packet exceeds 512 bytes, a client 102/165 can send the traffic over TCP, but handling TCP connection for TCP based DNS Query can add an additional challenge of establishing connection from client 102/165 to DNS server located customer data center. In another example, supporting split DNS option for both local and remote for TCP based DNS can be challenging as this can establish a TCP connection with DNS server before sending DNS query which can be intercepted to achieve split DNS for both local and remote. Meanwhile, split DNS both local and remote can mean that the DNS query for public FQDN may be resolved by public/local DNS server. The DNS query for private servers FQDN may be resolved by remote customer data center. A DNS query can go for multiple iterations with several types of records to finally resolve IP address. In another example, there can be several types of DNS Query records to be intercepted by client 102, cloud VPN 175 before authorizing it to allow or deny. These examples can result in issues or challenges, affecting for example the system performance and user experience.

The present solution provides for systems with a cloud VPN solution providing VPN tunnel access to private machines and servers 106 in customer data centers 350 for clients 102/165 in public network. The private machine/servers 106 are accessed either using IP address or FQDN by clients 102/165.

In addition to aforementioned examples, the Cloud VPN 175 (e.g., VPN servers 196) can establish individual TLS (Transport Layer Security) TCP tunnel for each TCP connection from clients to the private server in customer data center 350. The UDP and DNS packets can be multiplexed using single TLS/DTLS channel 330. The UDP/DNS packets can be encapsulated and sent over MUX channel 330 with their MUX Headers 315 with details of destination and packet types.

Client 102/165 can have an agent 120 (e.g., plugin) which can intercept DNS, TCP, UDP packets destined for private servers in the customer data center 350 and forward to cloud VPN 175. The client 102/165 can establish a channel 330 with the cloud VPN 175 and send DNS/UDP packets for multiple destinations servers in customer data center 350 through single channel 330. It can be expected that the cloud VPN 175 can multiplex the UDP/DNS packet to appropriate servers 106 in appropriate customer data center 350 and respond the UDP/DNS response packet back to client.

The cloud VPN 175 can establish back-end channels 330 for forwarding UDP/DNS packet to customer data center 330 that each can have an agent, and/or connector 405. The backend MUX channel from cloud VPN 175 can be established with connector 405 in customer data center. The connector 405 can receive the UDP/DNS packet through MUX header and can forward packets to appropriate UDP/DNS server.

The connector 405 can perform multiple roles for DNS resolution with DNS servers in data center. For example, the connector 405 of a data center 350 can register itself with cloud VPN 175 (e.g., VPN server 195) and can establish a persistent outbound connection to cloud VPN 175 for a control path. When the cloud VPN 175 wants to establish MUX channel 330 with a specific data center 350, the cloud VPN 175 (e.g., its VPN server 195, software 180, infrastructure 190 or platform 185) can send a request for establishing MUX channel 330 to the connector 405 in the specific data center 350 via the persistent control path connection. Connector 405 can establish a new outbound connection with cloud VPN 175 for UDP/DNS data path. This new data path connection can be used and maintained as backend MUX channel by cloud VPN 175.

Connector 405 can do additional task of decapsulating the DNS packets received over MUX Channel and can deliver to DNS server. The response from DNS server can be forwarded back to cloud VPN 175 in the same MUX channel in which it received the request. When the client application 305 accesses private TCP server 106 in customer data center 350 using IP address, the solutions discussed herein can establish tunnel/bit-pump connection to the TCP server in data center. For example, see FIG. 9.

The present solution can relate to an example design in which a TCP Connection establishment with a cloud VPN 175 uses a private Server IP address. For the purposes of clarity, this example design can be referred to as the Example Design 1. In the Example Design 1, a TCP connection can be established using multiple acts or steps. For example, at act one, the client application 305 attempts TCP connection establishment (through TCP 3-way handshake) using an IP address, such as IP_Address_1. At act two, the client agent 120 can intercept TCP-SYN for IP_Address_1. At act three, the client agent 120 can establish TLS based TCP Connection with cloud VPN 175. It can request cloud VPN 175 to establish tunnel with IP_Address_1 over the TLS connection. At act four, on receiving tunnel establishment request, the cloud VPN 175 can find the customer data center 350 and can request connector 405 in data center 350 to establish outbound connection with cloud VPN 175. At act five, on receiving the outbound connection from connector 405, the cloud VPN 175 can share IP_Address_1 to connector 405 to establish connection to the private server with IP_Address_1. At act six, the connector 405 can establish connection to IP_Address_1. If it succeeds, connector 405 can provide a success response to cloud VPN 175. At act seven, the cloud VPN 175, upon receiving the success response, can respond to the client agent 120 that tunnel can be established. At act eight, the client agent 120 can convert the TLS connection (established in step 3) as tunnel mode and respond for TCP-SYN for client application. At act nine, the client application 305 can complete the TCP handshake. At act ten, the client agent 120 can complete the TCP handshake (the TCP handshake packets are not forwarded to cloud VPN 175). At act eleven, the client application can send TCP packets over the established connection. The TCP packet can be forwarded in bit-pump mode / tunnel mode without intercepting. The client application 305 and private server in customer data center 350 can talk to each other by sending and receiving TCP packets over the tunnel.

In case that the client application 305 tries to access/connect to private server 106 using FQDN, the FQDN can be DNS name resolved remotely through the DNS server in customer data center 350 before accessing/connecting. DNS protocol can be supported over UDP based or TCP as well (UDP can be commonly used). The UDP based DNS query can be resolved using cloud VPN 175 by DNS server in customer data center 350 with the solution that can be example in FIG. 9.

In another example design, a basic UDP based DNS resolution can be implemented through MUX Channel 330 using cloud VPN 175. For the sake of clarity, this example design can be referred to as Example Design 2. The solution in Example Design 2 can be implemented using several acts or steps. For example, at act one, a client 102 can include a client agent 120 (e.g., plugin) that can establish dedicated TLS/DTLS based client-side MUX channel for UDP/DNS packets with cloud VPN 175 after the login by user. At act two, cloud VPN 175 can accept the client-side MUX channel 330 request from the client and retain the channel. At act three, the Client agent can intercept DNS packet from client applications, if DNS packet destination can be configured for the user to access over cloud VPN 175, it encapsulates and forwards the DNS packet over the client-side MUX channel. At act four, on receiving encapsulated DNS packet from a client-side MUX channel, the cloud VPN 175 can choose data center 350 to be forwarded for DNS query. At act five, if the backend MUX channel already exists for the DNS server located data center 350 in Lookup Table (e.g., 410), then the cloud VPN 175 can forward the encapsulated DNS Packet after authorization. At act six, if the backend MUX channel does not exist for the DNS server located data center 350 in lookup table (e.g., 410), then the cloud VPN 175 can request connector 405 (which has DNS server for resolution) to establish backend MUX channel 330 via the persistent control path connection. At act seven, once the backend MUX channel 330 can be established with connector 405, the cloud VPN 175 can forward the encapsulated DNS packet over the backend MUX channel. At act eight, the connector 405 can receive the encapsulated DNS packet and decapsulate and forward the DNS Packet to DNS server based on packet type and destination in MUX Header 315. At act nine, the response from DNS Server can be encapsulated by connector 405 and forwarded through the same backend MUX channel through which it received the request from cloud VPN 175. At act ten, the cloud VPN 175 can receive the encapsulated DNS packet and can parse the MUX header 315 for client details. The cloud VPN 175 can find the client-side MUX channel based on client details and forward the encapsulated DNS response. At act eleven, the client decapsulates and forwards the response to the client application based on client details on MUX header 315, in one or more embodiments.

There can be several types of records in DNS queries. Some examples, types of DNS records can include: A, AAAA, CNAME, MX, SOA, SRV, etc. With the solutions discussed herein, all the DNS records can be supported.

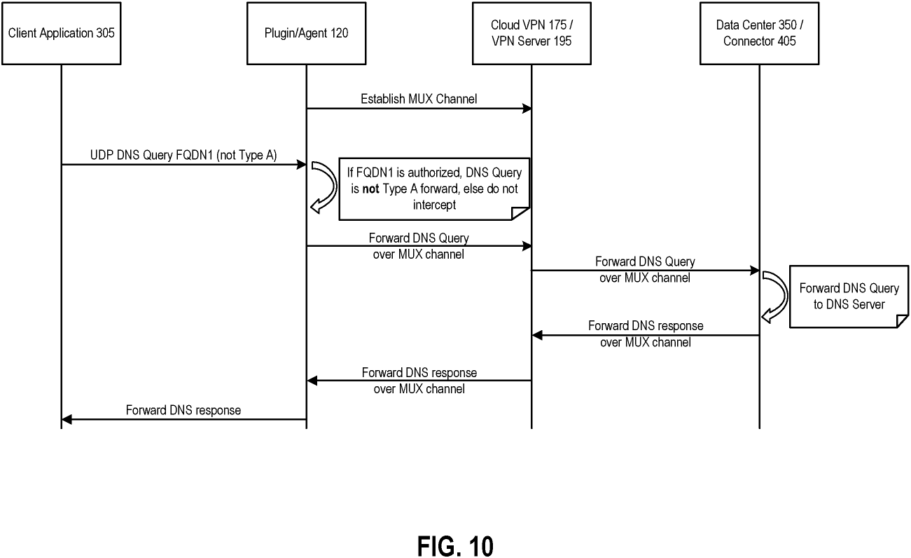

Referring now to FIG. 10, the present solution can relate to a method including steps for UDP DNS resolution by remote data centers 350. For example, the present solution can include a method for resolving DNS by Remote data center 350 using a series of steps or actions, such as those illustrated in FIG. 10. As shown in FIG. 10, a client application 305 can send a UDP DNS query FQDN1 to a plugin or agent 120 of the client 102/165. The UDP DNS query may exclude a type “A” DNS query. Agent 120 or plugin can establish a MUX channel with the cloud VPN 175 or VPN server 195. The agent 120 may already have a previously established MUX channel 330. The agent 120 can determine if FQDN1 is authorized. Agent 120 can determine if the DNS query is type A and in response to determining that it is not type A, it can forward the DNS query to the cloud VPN 175 or its VPN server 195 over a client-side MUX channel 330 established between the agent 120 and VPN server 195 (e.g., cloud VPN). Cloud VPN 175 (e.g., VPN server 195) can forward the DNS query over a back-end channel 330 between the VPN server 195 and data center 350, to the data center 350 or its connector 405. The connector 405 at the data center 350 can forward the DNS query to the DNS server at the data center 350. The connector 405 can receive the response to the DNS query from the DNS server and forward the DNS query over the established back-end channel 330 to the VPN server 195 (e.g., cloud VPN 175), which can further forward the DNS response over the established client-side channel 330 to the agent 120 (e.g., plugin) at the client 102/165. The agent 120 (e.g., plugin) can forward the DNS response back to the client application 305.

The present solution can also utilize a spoofing (or defined) IP address for DNS resolution. The present solution can relate to various DNS records, including “A” type records and “AAAA” type records. Resolving the hostname remotely can introduce latency to resolve to the private server IP address). The latency can be because the DNS packet may travel through WAN (Wide Area Network), cloud VPN 175, customer data center, which can take time and produce delays.

In an Example Design 1, discussed above, the private server FQDN_1 to IP_Address_1 can be resolved in act 6 of that example by connector 405 while finally connecting to private server 106, instead of client application 305 resolving it over MUX channel 305 as in that example. There can be an issue that the connector 405 can use the FQDN_1 to resolve to IP_Address_1. To address the issue, FQDN_1 can be shared to cloud VPN 175 in step/act 3 in the above-discussed Example Design 1, instead of IP_Address_1. There can also be another issue that the client application 305 can use an IP address to establish the TCP connection. To address this issue the client application can be spoofed with a fake/defined IP address by client agent for DNS resolution in the above Example Design 1, at act three. In addition, there can be an issue that the DNS query with record Type A/AAAA only responds to the IPV4 or IPV6 address. The client agent 120 (e.g., plugin) can intercept each DNS query and filter FQDN can be configured/authorized for user session. To support various DNS records type, the client agent 120 can parse the DNS packets. The Type A/AAAA DNS queries can be spoofed using a spoof IP address. Other types of DNS records can be forwarded to cloud VPN 175 for remote DSN resolution, such as described in Example Design 2.

The modified design for spoofing IP address for DNS record Type A/AAAA and cloud VPN 175 Tunnel establishment support with spoof IP are elaborated below.

The present solution can provide for a DNS name resolution with spoof IP. For example, an Example Design 3 can include a DNS name resolution with a spoof IP address. Example design 3 can include several steps or acts. At act one, the client 102/165 can include a client agent 120 (e.g., a plugin) which can establish dedicated TLS/DTLS-based client-side MUX channel 330 with cloud VPN 175. This channel 330 can be established after, or responsive to, the login by a user. At act two, the cloud VPN 175 can accept the client-side MUX channel 330 request from client and can retains retain the channel. At act three, the client agent 120 can intercept DNS packet from client applications 305. If a DNS packet is Type A/AAA, and the FQDN can be authorized for the user, the agent can populate the DNS response and respond with spoof IP address, such as for example by Spoof_IP_Address_1.

The present solution can provide for a TCP Connection establishment with cloud VPN 175 using spoof IP address. For example, in an Example Design 4, several acts or steps can be implemented to provide for a TCP connection establishment with a cloud VPN 175 using spoof IP address. At act one, a client application 305 can attempt a TCP connection establishment (e.g., via TCP 3-way handshake) using a Spoof_IP_Address_1 (Spoofed IP). At act two, the client agent can intercept TCP-SYN for Spoof_IP_Address_1 and can find the FQDN_1 mapped for this Spoof_IP_Address_1. At act three, the client agent 120 can establish TLS based TCP Connection with cloud VPN 175. The client agent 120 can request cloud VPN 175 to establish tunnel with FQDN_1 over the TLS connection. At act four, on receiving tunnel establishment request, the cloud VPN 175 can find the customer data center 350 for FQDN1 and can request connector 405 in data center 350 to establish outbound connection with cloud VPN 175. At act five, on receiving the outbound connection from connector 405, the cloud VPN 175 can send FQDN_1 to connector 405 to establish connection to the private server with FQDN_1. At act six, the connector 405 can resolve FQDN_1 to IP_Address_1. At act seven, the connector 405 can establish connection to IP_Address_1, and if succeeded, it can send a success response to cloud VPN 175. At act eight, the cloud VPN 175, on success response, can respond to client agent 12- that tunnel is established. At act nine, the client agent can convert the TLS Connection (established in step 3) as tunnel mode and responds for TCP-SYN for client application. At act ten, the client application can completes the TCP handshake. At act eleven, the client agent can complete the TCP handshake (the TCP handshake packets are not forwarded to cloud VPN 175). At act twelve, the client application can send TCP packets over the established connection. The TCP packet can be forwarded in bit-pump mode / tunnel mode without intercepting. The client application and private server in customer data center 350 can talk to each other by sending and receiving TCP packets over the tunnel.

Some client applications can send DNS packet over TCP connection in case the DNS packet exceeds a defined number of (e.g., 512) bytes. Some applications can always resolve hostnames through TCP based DNS query. The TCP connection for sending DNS query can be established with configured local/public DNS server in client machine using port number 53. The client application can send the DNS query over the TCP connection once after the TCP connection can be established for port 53.

In some implementations, if the client intercepts a TCP connection to port 53 like normal flow shown in the Example Design 1, client and cloud VPN can establish TLS based Tunnel (e.g., TCP connection) with DNS server in customer data and the client plugin/agent may not intercept the hostname in the DNS query which can be sent over the TLS based tunneled TCP connection. Hence all TCP based DNS requests (both for FQDN_1 in customer data center, public FQDN) can be resolved by remote customer data center’s DNS Server. The public FQDN resolving by customer data center 350 can be for TCP based DNS query should not be allowed. The TCP based DNS support can behave like “Split DNS as always remote”.

There can be issues involving “Split DNS as always remote” over a TLS tunnel. For example, a cloud VPN 175 can be unable to filter/deny DNS Query for forbidden Hostname/ domain as it cannot intercept the DNS packets in TLS tunnel. A client can be unable to send public TCP DNS query to the local DNS server. All the TCP based DNS queries are resolved by DNS server in customer data center. Client can be unable to split the TCP based DNS request to local and remote. For example, a DNS query record Type “A” / “AAAA” may not be spoofed.

The present solution can provide for a cloud VPN 175 intercepting and filtering TCP DNS Query over a MUX channel 330. For example, in an Example Design 5, several steps can be implemented to provide for a DNS packet sent over MUX channel to be intercepted and parsed by cloud VPN 175 or Client. In Example Design 5, a DNS can be sent query over MUX channel and be intercepted by cloud VPN 175. This can be done using several steps or acts.

For example, at act one, a client plugin can intercept a TCP connection to a port, such as a port number 53. The client plugin itself can behave like a DNS Server and allow establishing TCP connection from the client application to client plugin. At act two, after the TCP connection establishment, the client plugin (e.g., agent 120) can receive the DNS query in the TCP connection. The client plugin can encapsulate the DNS query and forward over the MUX channel to cloud VPN 175. At act three, the cloud VPN 175 can parse the encapsulated DNS query and if the hostname/domain can be (not pubic FQDN) is allowed/authorized, it can forward the encapsulated DNS query to the connector 405 in customer data center 350 over the backend MUX channel 330. The public FQDN DNS packets can be dropped. At act four, the connector 405 can receive the DNS query from MUX channel and decapsulate and forward the DNS query to the DNS Server. At act five, the response from DNS server can be forwarded to cloud VPN 175 in the MUX channel in which it received the DNS query. At act six, the response from connector 405 can be forwarded to client plugin by cloud VPN 175. At act seven, the client plugin can respond the DNS response over the established TCP connection with port 53 to the client application.

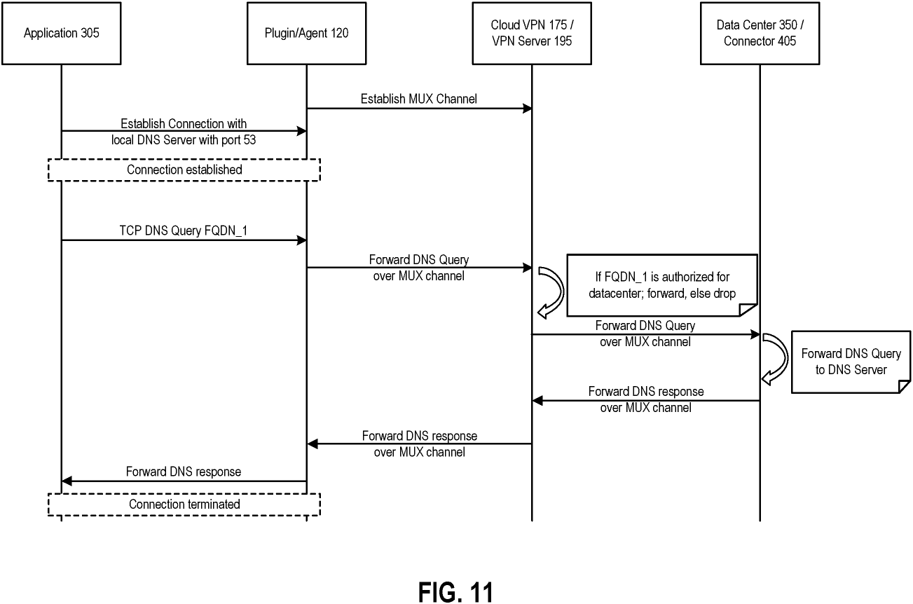

Referring now to FIG. 11, which can refer to a method of steps or acts for a solution for TCP DNS in which a cloud VPN can intercept and filter TCP DNS queries over MUX channel. The method example in FIG. 11 can be done, for example, in combination with Example Design 5.

In a greater detail, FIG. 11 can include an application 305 establishing a TCP connection with an agent 120 (e.g., plugin) at a client 102/165 using a local DNS server via port 53, such as for example done in connection with Example Design 5 above. The TCP connection can be established between the client 102/165 and application 305. The TC connection can be established so that application 305 is spoofed into thinking that it is establishing a connection with a DNS server instead of the agent 120, as discussed herein. Agent 120 can further establish a client-side channel 330 between agent 120 and cloud VPN 175 (e.g., VPN server 195 at the cloud). Client application 305 can send a TCP DNS query FQDN_1 to the agent 120. Agent 120 can forward the DNS query over the client-side MUX channel 330 to the cloud VPN 175/VPN server 195. At cloud VPN 175, a determination can be made by the VPN server 195 if FQDN_1 is authorized for data center 350. If VPN server 195 determines that it is authorized it can forward the DNS query and if it is not authorized it can drop the DNS query. In the event that the VPN server 195 determines that the FQDN_1 is authorized for the data center 350, VPN server 195 (e.g., cloud VPN) can forward the DNS query to the connector 405 of the data center 350, which can then forward the DNS query to the DNS server at the data center 350 over a back-end channel 330 between the cloud VPN 175 and the data center 330 (e.g., connector 405). The connector 405 (e.g., data center 350) can then receive and forward the DNS response from the DNS server over the back-end channel 330 to the VPN server 195 (e.g., cloud VPN 175), which can then forward the DNS response over the client-side channel 330 to the agent 120 (e.g., plugin), which can then forward the DNS response to the client application 305. The TCP connection between the agent 120 and the application 305 can then be terminated.

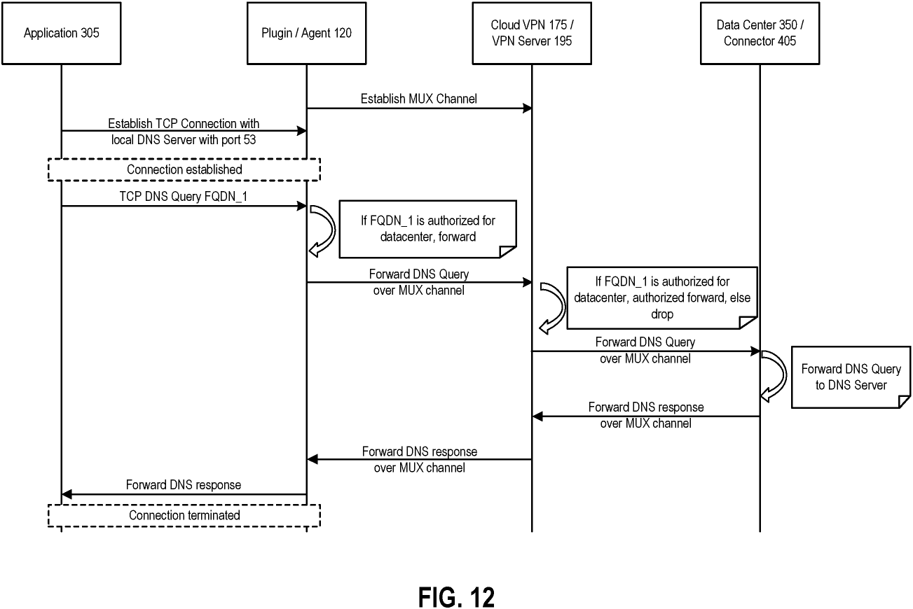

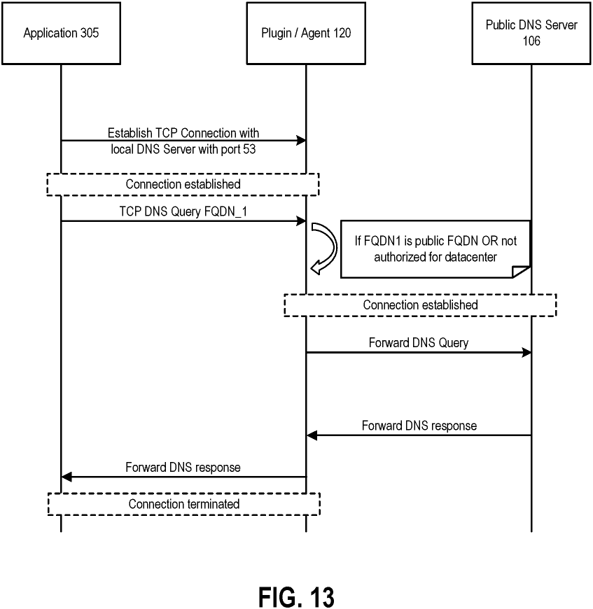

The present solution can also provide for the client to support split DNS both for TCP based DNS Query. This can be referred to as the Example Design 6 and can be shown or be combined with, for example, methods shown in FIGS. 12 and 13. In the example design 6, the problem of dropping public FQDN can be addressed. In the Example Design 6, several acts or steps can be used for the client plugin to handle public FQDN with public DNS server and remote data center FQDN with cloud VPN 175.

At act one, the client plugin (e.g., 120) can intercept the TCP connection to port number 53. The client plugin itself can behave like a DNS Server and allow establishing TCP connection from the client application to client plugin. At act two, after the TCP connection establishment, the client plugin can receive the DNS Query and can intercept the DNS Query. At act three, if the hostname/domain is for public DNS name/FQDN, the plugin can establish TCP connection with local/public DNS Server, and forward the DNS Query to public DNS server, the response can be forwarded to client application. In this case, the method can then continue on to act seven below. At act four, if the hostname/domain is authorized for the user and FQDN can be destined for customer data center, the DNS query can be encapsulated and forwarded over the dedicated MUX channel to cloud VPN 175. At act five, the cloud VPN 175 can parse the encapsulated DNS query and if the hostname/domain is allowed, it can forward the encapsulated DNS query to the connector 405 in customer data center 350. At act six, the connector 405 can decapsulate and forward the DNS Query to DNS server. At act seven, the response from DNS server can be forwarded to cloud VPN 175 in the MUX channel in which it received the DNS query. At act eight, the DNS response from the connector 405 can be forwarded to client plugin by cloud VPN 175. At act nine, the client plugin can respond the DNS response over the established TCP connection with port 53 to the client application.

Moreover, in design example 6, DNS records type query destined for customer data center 350 can be sent to cloud VPN 175 to resolve with connector 405.

FIG. 12 can relate to a method for TCP DNS solution providing for a client to support split DNS remote for TCP based DNS query. For example, as shown in FIG. 12, a client application 305 can establish a TCP connection with an agent 120 using a local DNS server using port 53. The connection can be established so that application 305 is spoofed into thinking that agent 120 is the DNS server. Agent 120 can establish a client-side MUX channel 330 with a cloud VPN 175 (e.g., VPN server 195). Application 305 can send a TCP DNS query FQDN_1 to the agent 120. Agent 120 can forward the DNS query of the client-side channel 330 to the cloud VPN 175 (e.g., VPN server 195). VPN server 195 can then determine if FQDN_1 is authorized for data center 350. If VPN server 195 determines that FQDN_1 is authorized for data center 350, VPN server 195 can forward the DNS query to the data center 350. Otherwise, VPN server 195 can drop the query. Upon forwarding the DNS query to data center 350 (e.g., connector 405), the DNS query can be forwarded by the connector 405 to a DNS server 106 inside of the data center 350. Connector 405 can receive the DNS response to the DNS query from the DNS server 106 and can forward the DNS response over the back-end channel 330 to the VPN server 195 (e.g., cloud VPN 175), which can forward the DNS response over the client-side channel 330 to the agent 120 (e.g., plugin), which can further forward the DNS response to the application 305. The TCP connection between the client application 305 and agent 120 can then be terminated.

FIG. 13 can relate to a method for TCP DNS solution providing for a client to support split DNS local for TCP based DNS query. For example, as shown in FIG. 13, a client application 305 can establish a TCP connection with an agent 120 using a TCP connection with local DNS server via port 53. For example, application 305 can be spoofed by agent 120 (e.g., plugin) that a TCP connection is being established with a DNS server, where in fact it is being established with the agent 120. Once the connection is established between the agent 120 and the application 305, a TCP DNS query FQDN1 can be transmitted from the application 305 to the agent 120 (e.g., plugin). Agent 120 can then determine if the FQDN1 is public FQDN or if it is not authorized for a data center 350. Responsive to determination that FQDN1 is a public FQDN and/or a determination that FQDN1 is authorized for data center, a connection between the agent 120 and a public DNS server 106 can be established. Agent 120 can forward the DNS query to the public DNS server 106. The public DNS server can provide to the agent 102 a response responsive to the DNS query. Agent 120 can forward the DNS response to the application 305. The connection between the application 305 and the agent 120 can then be terminated.

The present solution can provide for a client to spoof an IP address for TCP based DNS query for record Type “A″/“AAAA”. This can be referred to as Example Design 7 in which optimization of spoofing IP address for Type A/AAAA records can be achieved over TCP DNS. Example Design 7 can include a method having several acts or steps.

At act one, the client 120 (e.g., plugin) can intercept the TCP connection to port number 53 and client plugin itself can behave like a DNS Server. The client 120 can allow establishing TCP connection from the client application to client plugin.

At act two, after the TCP connection establishment, the client plugin can intercept the DNS Query. At act three, if the hostname/domain is for public DNS name/FQDN, the plugin can establish TCP connection with local DNS Server, and forward the DNS Query to local DNS server. The response can be forwarded to client application. In the event this occurs, the method can continue to act or step 7 below. At act four, if the hostname/domain is authorized for the user, FQDN can be destined to customer data center and the DNS Query record Type can be A/AAAA. The IP address can be spoofed by client plugin. At act five, if the hostname/domain is authorized for the user and the DNS Query record Type is not A/AAAA, the DNS query can be encapsulated and forwarded over the dedicated MUX channel to cloud VPN 175. At act six, the cloud VPN 175 can parse the encapsulated DNS query and if the hostname/domain is allowed, it can forward the encapsulated DNS query to the connector 405 in customer data center. At act seven, the connector 405 can decapsulate and forward the DNS Query to DNS server. At act eight, the response from DNS server can be forwarded to cloud VPN 175 in the MUX channel in which it received the DNS query. At act nine, the DNS response from the connector 405 can be forwarded to client plugin by cloud VPN 175. At act ten, the client plugin can respond the DNS response over the established TCP connection with port 53 to the client application.

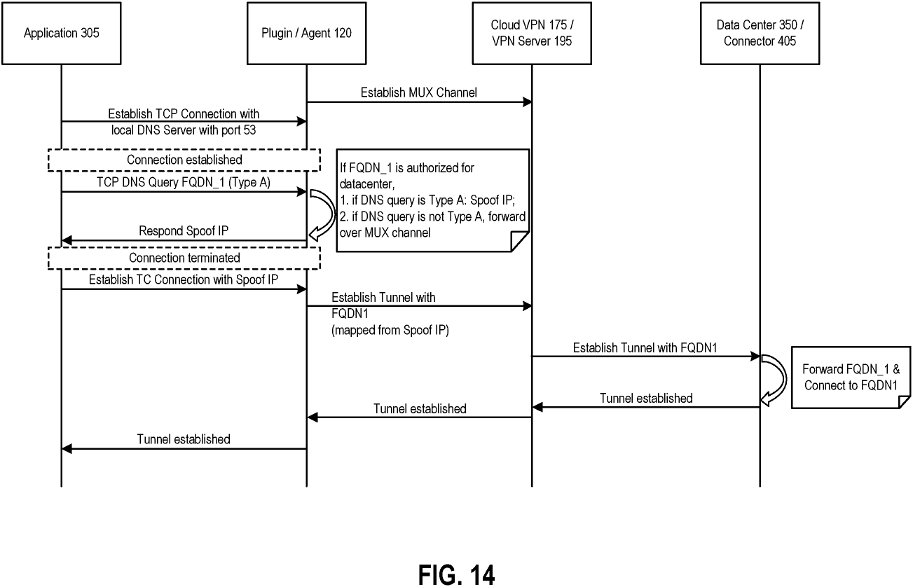

Example Design 7 can be used in combination with steps or acts discussed in connection with FIG. 14. FIG. 14 can relate to a method for TCP DNS solution providing for a client to spoof IP for TCP based DNS query for records type “A” and/or “AAAA”. The method example in FIG. 14 can include several steps or acts.

An application 305 can establish a TCP connection with an agent 120. The established connection can be a TCP connection with local DNS server via port 53. Application 305 can be spoofed into thinking that agent 120 is the DNS server. Application 305 can send a TCP DNS query FQDN_1 (type A) to the agent 120. Agent 120 can establish a client-side MUX channel 330 with VPN server 195 or cloud VPN 175. Agent 120 can determine if the FQDN_1 is authorized for the data center 350. Agent 120 can also determine if the DNS query is a type “A” query. If it determines that it is a type “A” query and/or that it is authorized, agent 120 can provide a response to the DNS query with a spoof IP and connection can be terminated. If the query is determined not to be type “A”, then agent 120 can forward the DNS query over the client-side MUX channel 330 to the cloud VPN 175.

Once application 305 receives the spoof IP, application 305 can send a request to establish a TC connection using the spoof IP provided by the agent 120. Agent 120 can establish a tunnel to the cloud VPN 175 (e.g., VPN server 195) using FQDN1 that can be mapped from spoof IP. Cloud VPN 175 can establish a back-end tunnel using FQDN1 to the data center 350 (e.g., connector 405). Connector 405 can forward the FQDN1 to the server to resolve the FQDN1 and connect to the FQDN1. Connector 405 can then establish a tunnel from data center 350 to the cloud VPN 175, which can establish a tunnel from cloud VPN 175 to agent 120, which can establish a tunnel to the application 305.

Therefore, the present solution provides for systems and methods in which the use case of distributed customer data center 350 and multi-region and multi-tenant cloud VPN 175 is resolved for various types of network communication. Multi-region and multi-tenant cloud VPN 175 can achieve DNS packet authorization, forwarding of the DNS packet to a customer data center’s DNS Server and get it resolved remotely by cloud VPN 175. The present solution can optimize type A/AAAA DNS resolution using Spoofing IP address for both UDP and TCP based DNS request. The present solution can provide for a client that can split the DNS request and forward the DNS query for public FQDN to public DNS server, DNS query for FQDN in customer data centers through cloud VPN 175.

In another aspect, the present solution relates to a method 1500 of managing network traffic between clients and remote data centers across cloud VPN. The present solution can include a series of acts, such as acts 1505-1545 of the method 1500 that can provide for delivering packets, such as UDP data packets, from clients to the intended servers located at various remote data centers (e.g., DMZs). Act 1505 can include receiving a packet. At act 1510, a header for the packet can be generated. At act 1515, a channel to VPN can be established. At act 1520, a UDP packet can be encapsulated. At act, 1525, the encapsulated UDP packet can be transmitted to the VPN. At act 1530, a data center can be identified. At act 1535, a channel to the data center can be selected. At act 1540, the encapsulated UDP packet to the data center can be transmitted. At act 1545, the packet to the destination server can be provided.

Act 1505 can include receiving/intercepting a packet. The packet can be a user datagram protocol (UDP) packet and it can be received by an agent or a plugin of a client device. The packet can include a DNS packet or a request. The packet can include a TCP packet. The packet can include a packet for TCP connection or a TCP DNS query. The packet can include any packet, transmission or a part of a transmission sent to the agent 120 in FIGS. 3-14. The UDP packet can be received by the client agent from an application of the client device.

The agent or a plugin can receive a UDP domain name system (DNS) query from an application of the client device. The agent can transmit to the application a UDP DNS response using a first internet protocol (IP) address and can receive the UDP packet via a transmission control protocol (TCP) connection established between the application and the agent using the first IP address.

At act 1510, a header for the packet can be generated to encapsulate the UDP packet. The agent (e.g., plugin) can generate a header for the UDP packet identifying a destination server at a data center of a plurality of data centers. The agent can encapsulate the UDP packet using the header. The encapsulated UDP packet can be configured to identify, based on the table of the VPN server, a connector of the data center to which to forward the encapsulated data packet to the destination server. The agent can generate/form/establish the content of the header identifying the client device, the destination server, a length of the encapsulated UDP packet and/or an identification of the user session corresponding to the UDP packet.

The agent can receive a second UDP packet. The agent can generate a second header for the second UDP packet identifying a second destination server at a second data center of a plurality of data centers. The second header can identify/determine a second UDP server at a second data center that can be different than the data center of the UDP packet received at act 1505.

At act 1515, a channel to VPN can be established. The agent (e.g., plugin) can establish a channel to a virtual private network (VPN) server of a cloud-based VPN as a service. The channel can be established by a VPN server of the cloud VPN. The channel can be established based on or using one of a datagram transport layer security (DTLS) or a transport layer security (TLS). The channel can be established based on DTLS or TLS in combination with a TCP.

At act, 1520, the encapsulated packet can be transmitted to the VPN. The encapsulated packet can be a UDP packet. The agent (e.g., plugin) can transmit, via the channel, the encapsulated UDP packet to the VPN server. The transmitted encapsulated UDP packet can be configured to identify the data center according to a table of the VPN server and content of the header.

The agent can also, upon encapsulating the second UPD packet using the second header from act 1510, transmit, via the channel, the encapsulated second UDP packet to the VPN server. The encapsulated second UDP packet can be configured to identify the second data center according to the table of the VPN server and content of the second header.

At act 1525, a data center can be identified. The data center can be identified by the VPN server. The VPN server can identify the data center from a plurality of data centers. The VPN server can identify the data center according to a table (e.g., routing table) of the VPN server matching a portion of the header of the encapsulated UDP packet. The data center can include the destination server, which can be the intended destination server of the UDP packet. The data center can be identified in response to receiving, by a virtual private network (VPN) server of a cloud-based VPN as a service, an encapsulated user datagram protocol (UDP) packet comprising a header identifying a destination server at the data center.

At act 1530, a channel to the data center can be selected. The VPN server can select, responsive to identifying the data center, a channel between the VPN server and a connector of the data center. The VPN server can determine that a channel to the data center is not established based on a table, such as a lookup table. In response to determining that the channel is not established, the VPN server can establish the channel to the data center. The channel between the VPN server and the data center can be established using or based on DTLS and/or TLS, or any other technique described for example at act 1515. The channel can be established between the VPN server and the connector of the data center.

At act 1535, the encapsulated UDP packet to the data center can be transmitted. The encapsulated UDP packet can be transmitted by the VPN server and via the channel between the VPN server and the connector of the data center. The transmitted encapsulated UDP packet can be configured or include information for the connector at the data center to identify the intended destination server from a plurality of destination servers of the data center.

At act 1540, the packet can be provided to the destination server. The packet can be forwarded to the destination server at the data center by the connector. The connector can identify the destination server based on the header of the encapsulated received UPD packet. The content of the header of the encapsulated UDP packet can identify the destination server of a plurality of destination servers at the data center of the connector. Identification of the destination server in the header can be unique to the data center and can include an IP address or an FQDN. The connector can decapsulate the encapsulated UDP packet and can forward the decapsulated UDP to the destination server.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by an agent of a client device, a user datagram protocol (UDP) packet;
generating, by the agent, a header for the UDP packet identifying a destination server at a data center of a plurality of data centers;
establishing, by the agent, a channel to a virtual private network (VPN) server of a cloud-based VPN as a service;
encapsulating, by the agent, the UDP packet using the header; and
transmitting, by the agent via the channel, the encapsulated UDP packet to the VPN server, the encapsulated UDP packet configured to identify the data center according to a table of the VPN server and content of the header.

2. The method of claim 1, wherein the encapsulated UDP packet is further configured to identify, based on the table of the VPN server, a connector of the data center to which to forward the encapsulated UDP data packet.

3. The method of claim 1, further comprising receiving, by the agent, the UDP packet from an application of the client device.

4. The method of claim 1, further comprising establishing, by the agent, the channel to the VPN server, using one of a datagram transport layer security (DTLS) or a transport layer security (TLS).

5. The method of claim 1, further comprising generating, by the agent, the content of the header identifying the client device, the destination server, a length of the encapsulated UDP packet and an identification of the user session corresponding to the UDP packet.

6. The method of claim 1, further comprising:
receiving, by an agent of a client device, a second UDP packet;
generating, by the agent, a second header for the second UDP packet identifying a second destination server at a second data center of a plurality of data centers;
encapsulating, by the agent, the second UDP packet using the header;
transmitting, by the agent via the channel, the encapsulated second UDP packet to the VPN server, the encapsulated second UDP packet configured to identify the second data center according to the table of the VPN server and content of the second header.

7. The method of claim 1, further comprising:
receiving, by the agent, a UDP domain name system (DNS) query from an application of the client device;
transmitting, by the agent to the application, a UDP DNS response using a first internet protocol (IP) address; and
receiving, by the agent, the UDP packet via a transmission control protocol (TCP) connection established between the application and the agent using the first IP address.

8. A method comprising:
receiving, by a virtual private network (VPN) server of a cloud-based VPN as a service, an encapsulated user datagram protocol (UDP) packet comprising a header identifying a destination server;
identifying, by the VPN server from a plurality of data centers, according to a table of the VPN server matching a portion of the header of the encapsulated UDP packet, a data center having the destination server;
selecting, by the VPN server responsive to identifying the data center, a channel between the VPN server and a connector of the data center; and
transmitting, by the VPN server via the channel to the connector of the data center, the encapsulated UDP packet for the connector to identify the destination server from a plurality of destination servers of the data center.

9. The method of claim 8, further comprising establishing, by one of the connector or the VPN server, the channel to the connector using one of a datagram transport layer security (DTLS) or a transport layer security (TLS).

10. A method of claim 8, further comprising identifying, by the VPN server, the data center according to an entry in the table of the server matching one of an IP address or a domain name of the header.

11. A system, comprising:
an agent executing on a processor of a client device coupled to memory, to:
receive a user datagram protocol (UDP) packet;
generate a header for the UDP packet identifying a destination server at a data center of a plurality of data centers;
establish a channel to a virtual private network (VPN) server of a cloud-based VPN as a service;
encapsulate the UDP packet using the header; and
transmit, via the channel, the encapsulated UDP packet to the VPN server, the encapsulated UDP packet configured to identify the data center according to a table of the VPN server and content of the header.

12. The system of claim 11, wherein the encapsulated UDP packet is further configured to identify, based on the table of the VPN server, a connector of the data center to which to forward the encapsulated data packet.

13. The system of claim 11, wherein the agent further receives the UDP packet from an application of the client device.

14. The system of claim 11, wherein the agent further establishes the channel to the VPN server using one of a datagram transport layer security (DTLS) or a transport layer security (TLS).

15. The system of claim 11, wherein the agent further generates the content of the header identifying the client device, the destination server, a length of the encapsulated UDP packet and an identification of the user session corresponding to the UDP packet.

16. The system of claim 11, wherein the agent:
receives a second UDP packet;
generates a second header for the second UDP packet identifying a second destination server at a second data center of the plurality of data centers;
encapsulates the second UDP packet using the second header;
transmits, via the channel, the second encapsulated UDP packet to the VPN server, the second encapsulated UDP packet configured to identify the second data center according to the table of the VPN server and content of the second header.

17. The system of claim 11, wherein the agent:
receives a UDP domain name system (DNS) query from an application of the client device;
transmits, to the application, a UDP DNS response using a first internet protocol (IP) address; and
receives the UDP packet via a TCP connection established between the application and agent using the first IP address.

18. The system of claim 11, wherein the encapsulated UDP packet is further configured for a connector of the data center to identify the destination server of a plurality of destination servers of the data center.

19. The system of claim 18, wherein the agent:
receives, from the VPN server via the channel, a second encapsulated UDP packet comprising a second UDP packet sent from the destination server to an application of the client device;
decapsulates the second encapsulated UDP packet to extract the second UDP packet; and
transmits the second UDP packet to the application.

20. The system of claim 19, wherein the agent identifies the application according to a second header of the second encapsulated UDP packet.
